(19) United States
(12) Patent Application Publication
(10) Pub. No.: US 2021/0132561 A1
(43) Pub. Date: May 6, 2021

(54) TECHNOLOGIES FOR SMART HOME AUTOMATION AND SMART HOME AUTOMATION PLATFORMS

(71) Applicant: Omni Automation, Inc., Carmel, IN (US)

(72) Inventors: Stephe Blansette, Carmel, IN (US); Brandon Fischer, Carmel, IN (US); Keenan Hecht, Carmel, IN (US); Jeff Burch, Zionsville, IN (US); Ken Winner, Carmel, IN (US); Stephan Nagy, Fishers, IN (US)

(73) Assignee: Omni Automation, Inc., Carmel, IN (US)

(21) Appl. No.: 17/091,968

(22) Filed: Nov. 6, 2020

Related U.S. Application Data
(60) Provisional application No. 62/931,558, filed on Nov. 6, 2019.

(51) Int. Cl. G05B 19/042

(52) U.S. Cl. CPC G05B 19/042; G05B 2219/2642

(57) ABSTRACT

One or more devices, systems, methods, may implement one or more techniques to for the home (e.g., residential) market, an (e.g., OMNI Smart Home) Automation Platform may be installed and/or integrated into a home, commercial location, service location, business location, industrial location, and/or military location. One or more techniques may use a state-of-the-art intuitive user interface for setup and/or day-to-day operation. An (e.g., a single) application may connects one or more devices, and/or everything, that may be found within the home. There may be full WiFi coverage throughout the home, perhaps with no more “dead zones.” Home automation platforms (e.g., OMNI) may learn and/or remember the location of people, pets, and/or objects inside the home. Perhaps using one or more (e.g., proprietary) Artificial Intelligence (AI) algorithms, the (e.g., Omni Core Home) Automation Platform may recognize patterns and/or may program itself with repeatable patterns over time.

### CROSS REFERENCE TO RELATED APPLICATION

The present application is a nonprovisional patent application, which claims the priority benefit of U.S. Application Ser. No. 62/931,558, filed Nov. 6, 2019, the text and drawings of which are hereby incorporated in its entirety.

### BACKGROUND

In many residential, commercial, and/or industrial environments, occupants may control lights, room temperature, and/or alarm/security systems inside and/or outside buildings or rooms thereof. Occupants may control lights via individual or grouped light switches. Room temperature may be controlled via remote or local thermostatic controllers. Occupants can control and/or monitor alarm/security systems, television systems, and/or music systems via controllers/monitors located in various rooms and/or centrally in a building.

### SUMMARY

One or more devices, systems, methods, may implement one or more techniques for implementing an automation platform (e.g., an OMNI Smart Home) and/or may include a network of proprietary devices installed in (e.g., primary) rooms throughout the site. These devices, processes, and/or techniques may form a neural network that may work together to recognize patterns in the daily routine of people, pets, and/or other repeatable activities, such as for example, identifying/recognizing individual users and/or user profiles.

The platform can be utilized in residential (e.g., home), commercial, industrial, military, and/or potentially any site that for which on-site automation for a variety of applications may be useful.

One or more techniques may be used in one or more targeted industries/environments such as Residential, Commercial, Smart Home Automation, Home Services, and/or IoT, and/or the like.

### BRIEF DESCRIPTION OF DRAWINGS

The embodiments and other features, advantages and disclosures contained herein, and the manner of attaining them, will become apparent and the present disclosure will be better understood by reference to the following description of various examples of the present disclosure taken in conjunction with the accompanying drawings, wherein:

FIG. 1 is an example diagram of a computer/processing device wherein one or more of the techniques of the disclosure may be implemented;

FIG. 2 illustrates an example illustration of some of the services used in one or more environments for which one or more techniques may be useful;

FIG. 3 illustrates an example schematic of one or more techniques described herein;

FIG. 4 illustrates an example illustration of at least one input/device that may be used with one or more techniques;

FIG. 5 is an example schematic of one or more techniques described herein;

FIG. 6 is an example illustration of at least one input/device that may be used with one or more techniques;

FIG. 7 is an example of one or more techniques described herein;

FIG. 8 is an example illustration of at least one input/device that may be used with one or more techniques;

FIG. 9 is an example of one or more techniques described herein;

FIG. 10 illustrates an example illustration of at least one input/device that may be used with one or more techniques;

FIG. 11 is an example illustration of a ceiling sensor package/smoke detector;

FIG. 12 is an example illustration of an exploded sensor touch light switch;

FIG. 13 is an example illustration of an assembled sensor touch light switch;

FIG. 14 is an example illustration of an exploded sensor outlet;

FIG. 15 is an example illustration of an assembled sensor outlet;

FIG. 16 is an example illustration of an sensor outlet;

FIG. 17 is an example illustration of an alpha-string button assembly;

FIG. 18 is an example illustration of a backpack assembly;

FIG. 19 is an example illustration of a camera add-on assembly;

FIG. 20 is an example illustration of a control system dashboard;

FIG. 21 is an example of control system definitions;

FIG. 22A to FIG. 22D is an example illustration of an ebutton assembly and configuration;

FIG. 23 is an example illustration of an executive overview of the control system;

FIG. 24 is an example illustration of a home automation feedback loop;

FIG. 25 is an example illustration of a control system deployed in a house;

FIG. 26A to FIG. 26C is an example illustration of an in-wall dimmer full device;

FIG. 27 is an example illustration of an insight training model;

FIG. 28A and FIG. 28B depict example illustrations of a lighthouse model;

FIG. 29 is an example illustration of an ML system and process;

FIG. 30A to FIG. 30C depict illustrations of a mobile interface for the control system;

FIG. 31 is an example flowchart of control system programming;

FIG. 32 is an example illustration of control system configuration;

FIG. 33 is an example illustration of an eco-system;

FIG. 34 is an example illustration of a main floor with a control system implementation;

FIG. 35 is an example illustration of a product displacement;

FIG. 36 is an example illustration of programming process;

FIG. 37 is an example illustration of server-side configuration for the control system;

FIG. 38 is an example illustration of control system software;

FIG. 39 is an example illustration of control system communication;

FIG. 40A to FIG. 40M depict example illustrations of templates and/or screenshots for one or more elements of the control system;

FIG. 41 is an illustration of an example of a configuration scheme for the control system;

FIG. 42A and FIG. 42B depict an illustration of an example of a configuration scheme for the control system;

FIG. 43A and FIG. 43B depict an illustration of an example use case of the control system; and

FIG. 44 is an example illustration of an interaction cycle with the control system.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

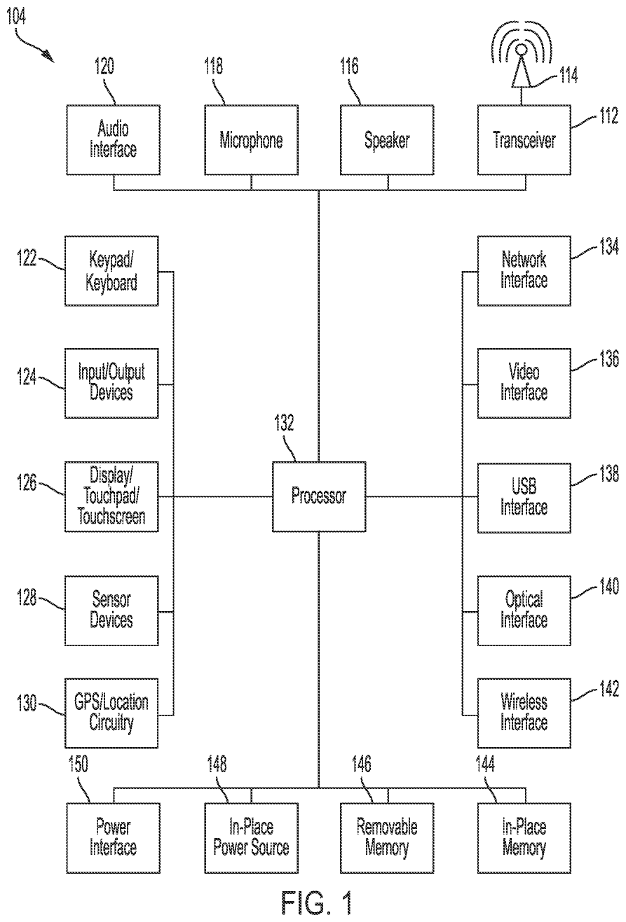

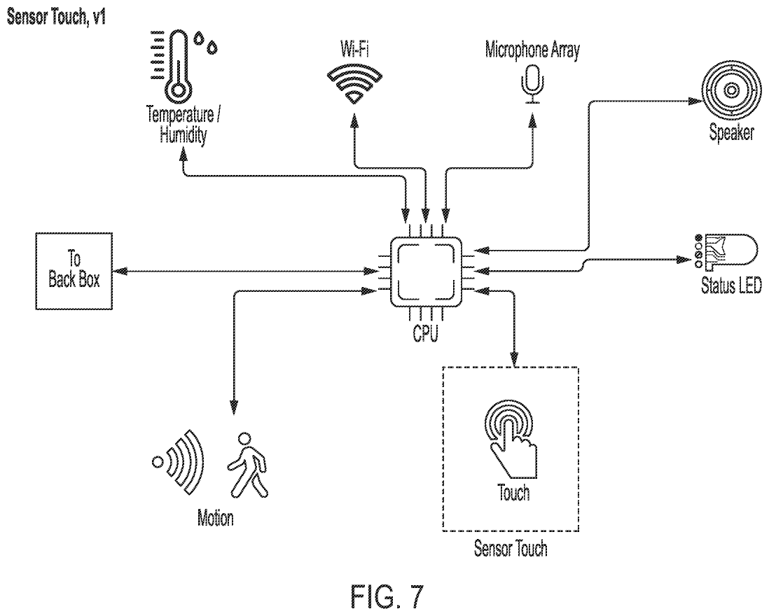

FIG. 1 is a diagram of an example computer/computing (e.g., processing) device 104 that may implement one or more techniques described herein, in whole or at least in part, with respect to one or more of the devices, methods, and/or systems described herein. In FIG. 7, the computing device 104 may include one or more of: a processor 132, a transceiver 112, a transmit/receive element (e.g., antenna) 114, a speaker 116, a microphone 118, an audio interface (e.g., earphone interface and/or audio cable receptacle) 120, a keypad/keyboard 122, one or more input/output devices 124, a display/touchpad/touch screen 126, one or more sensor devices 128, Global Positioning System (GPS)/location circuitry 130, a network interface 134, a video interface 136, a Universal Serial Bus (USB) Interface 138, an optical interface 140, a wireless interface 142, in-place (e.g., non-removable) memory 144, removable memory 146, an in-place (e.g., removable or non-removable) power source 148, and/or a power interface 150 (e.g., power/data cable receptacle). The computing device 104 may include one or more, or any sub-combination, of the aforementioned elements.

The computing device 104 may take the form of a laptop computer, a desktop computer, a computer mainframe, a server, a terminal, a tablet, a smartphone, a cloud-based computing device (e.g., at least partially), a light switch, and/or a modular component, and/or the like.

The processor 132 may be a general-purpose processor, a special-purpose processor, a conventional processor, a digital-signal processor (DSP), a plurality of microprocessors, one or more microprocessors in association with a DSP core, a controller, a microcontroller, one or more Application Specific Integrated Circuits (ASICs), one or more Field Programmable Gate Array (FPGAs) circuits, any other type of integrated circuit (IC), and/or a finite-state machine, and/or the like. The processor 132 may perform signal coding, data processing, power control, sensor control, interface control, video control, audio control, input/output processing, and/or any other functionality that enables the computing device 104 to serve as and/or perform as (e.g., at least partially) one or more of the devices, methods, and/or systems disclosed herein.

The processor 132 may be connected to the transceiver 112, which may be connected to the transmit/receive element 124. The processor 132 and the transceiver 112 may operate as connected separate components (as shown). The processer 132 and the transceiver 112 may be integrated together in an electronic package or chip (not shown).

The transmit/receive element 114 may be configured to transmit signals to, and/or receive signals from, one or more wireless transmit/receive sources (not shown). For example, the transmit/receive element 114 may be an antenna configured to transmit and/or receive RF signals. The transmit/receive element 114 may be an emitter/detector configured to transmit and/or receive IR, UV, or visible light signals, for example. The transmit/receive element 114 may be configured to transmit and/or receive RF and/or light signals. The transmit/receive element 114 may be configured to transmit and/or receive any combination of wireless signals.

Although the transmit/receive element 114 is shown as a single element, the computing device 104 may include any number of transmit/receive elements 114 (e.g., the same as for any of the elements 112-150). The computing device 104 may employ Multiple-Input and Multiple-Output (MIMO) technology. For example, the computing device 104 may include two or more transmit/receive elements 114 for transmitting and/or receiving wireless signals.

The transceiver 112 may be configured to modulate the signals that are to be transmitted by the transmit/receive element 114 and/or to demodulate the signals that are received by the transmit/receive element 114. The transceiver 112 may include multiple transceivers for enabling the computing device 104 to communicate via one or more, or multiple, radio access technologies, such as Universal Terrestrial Radio Access (UTRA), Evolved UTRA (E-UTRA), and/or IEEE 802.11, for example. The transceiver 112 may include transceivers for communicating via WiFi, Zigby, Z Wave, Bluetooth, and/or proprietary RF.

The processor 132 may be connected to, may receive user input data from, and/or may send (e.g., as output) user data to: the speaker 116, microphone 118, the keypad/keyboard 122, and/or the display/touchpad/touchscreen 126 (e.g., a liquid crystal display (LCD) display unit or organic light-emitting diode (OLED) display unit, among others). The processor 132 may retrieve information/data from and/or store information/data in, any type of suitable memory, such as the in-place memory 144 and/or the removable memory 146. The in-place memory 144 may include random-access memory (RAM), read-only memory (ROM), a register, cache memory, semiconductor memory devices, and/or a hard disk, and/or any other type of memory storage device.

The removable memory 146 may include a subscriber identity module (SIM) card, a portable hard drive, a memory stick, and/or a secure digital (SD) memory card, and/or the like. The processor 132 may retrieve information/data from, and/or store information/data in, memory that might not be physically located on the computing device 104, such as on a server, the cloud, and/or a home computer (not shown).

One or more of the elements 112-146 may receive power from the in-place power source 148. In-place power source 148 may be configured to distribute and/or control the power to one or more of the elements 112-146 of the computing device 104. The in-place power source 148 may be any suitable device for powering the computing device 104. For example, the in-place power source 148 may include one or more dry cell batteries (e.g., nickel-cadmium (NiCd), nickel-zinc (NiZn), nickel metal hydride (NiMH), lithium-ion (Li-ion), etc.), solar cells, and/or fuel cells, and/or the like.

Power interface 150 may include a receptacle and/or a power adapter (e.g., transformer, regulator, and/or rectifier) that may receive externally sourced power via one or more AC and/or DC power cables, and/or via wireless power transmission. Any power received via power interface 150 may energize one or more of the elements 112-146 of computing device 104, perhaps for example exclusively or in parallel with in-place power source 148. Any power received via power interface 150 may be used to charge in-place power source 148.

The processor 132 may be connected to the GPS/location circuitry 130, which may be configured to provide location information (e.g., longitude and/or latitude) regarding the current location of the computing device 104. The computing device 104 may acquire location information by way of any suitable location-determination technique.

The processor 132 may be connected to the one or more input/output devices 124, which may include one or more software and/or hardware modules that provide additional features, functionality and/or wired and/or wireless connectivity. For example, the one or more input/output devices 124 may include a digital camera (e.g., for photographs and/or video), a hands free headset, a digital music player, a media player, a frequency modulated (FM) radio unit, an Internet browser, and/or a video game player module, and/or the like.

The processor 132 may be connected to the one or more sensor devices 128, which may include one or more software and/or hardware modules that provide additional features, functionality and/or wired and/or wireless connectivity. For example, the one or more sensor devices 128 may include an accelerometer, an e-compass, and/or a vibration device, and/or the like.

The processor 132 may be connected to the network interface 134, which may include one or more software and/or hardware modules that provide additional features, functionality and/or wireless and/or wired connectivity. For example, the network interface 134 may include a Network Interface Controller (NIC) module, a Local Area Network (LAN) module, an Ethernet module, a Physical Network Interface (PNI) module, and/or an IEEE 802 module (e.g., one or more IEEE 802.11 standard series protocols), and/or the like.

The processor 132 may be connected to the video interface 136, which may include one or more software and/or hardware modules that provide additional features, functionality and/or wired and/or wireless connectivity. For example, the video interface 136 may include a High-Definition Multimedia Interface (HDMI) module, a Digital Visual Interface (DVI) module, a Super Video Graphics Array (SVGA) module, and/or a Video Graphics Array (VGA) module, and/or the like.

The processor 132 may be connected to the USB interface 138, which may include one or more software and/or hardware modules that provide additional features, functionality and/or wired and/or wireless connectivity. For example, the USB interface 138 may include a universal serial bus (USB) port, and/or the like.

The processor 132 may be connected to the optical interface 140, which may include one or more software and/or hardware modules that provide additional features, functionality and/or wired and/or wireless connectivity. For example, the optical interface 140 may include a read/write Compact Disc module, a read/write Digital Versatile Disc (DVD) module, and/or a read/write Blu-ray™ disc module, and/or the like.

The processor 132 may be connected to the wireless interface 142, which may include one or more software and/or hardware modules that provide additional features, functionality and/or wireless connectivity. For example, the wireless interface 142 may include a Bluetooth® module, an Ultra-Wideband (UWB) module, a Z Wave module, a cellular module, a ZigBee module, and/or a Wi-Fi (IEEE 802.11) module, and/or the like.

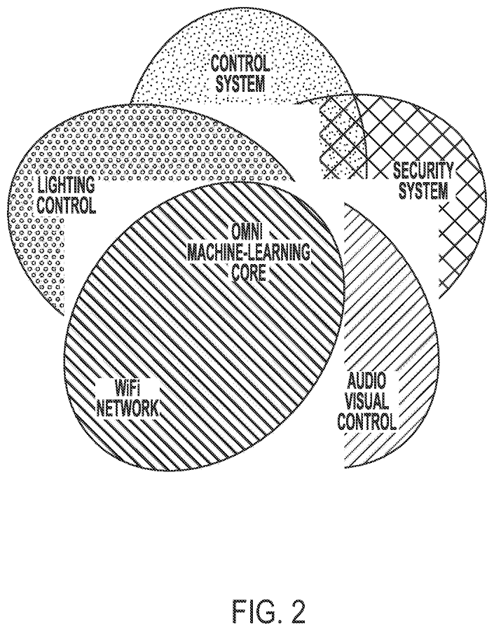

FIG. 2 illustrates an example illustration of some of the services used in one or more environments for which one or more techniques may be useful.

One or more devices, systems, methods, may implement one or more techniques to for the home (e.g., residential) market, an (e.g., OMNI Smart Home) Automation Platform may be installed and/or integrated into a home, commercial location, service location, business location, industrial location, and/or military location. One or more techniques may use a state-of-the-art intuitive user interface for setup and/or day-to-day operation. An (e.g., a single) application may connects one or more devices, and/or everything, that may be found within the home.

There may be full WiFi coverage throughout the home, perhaps with no more “dead zones.” Home automation platforms (e.g., OMNI) may learn and/or remember the location of people, pets, and/or objects inside the home. Perhaps using one or more (e.g., proprietary) Artificial Intelligence (AI) algorithms, the (e.g., Omni Core Home) Automation Platform may recognize patterns and/or may program itself with repeatable patterns over time. The control device/home automation platform (e.g., OMNI device) may be provide the device and/or extend Wifi and/or cellular coverage in the home and/or business.

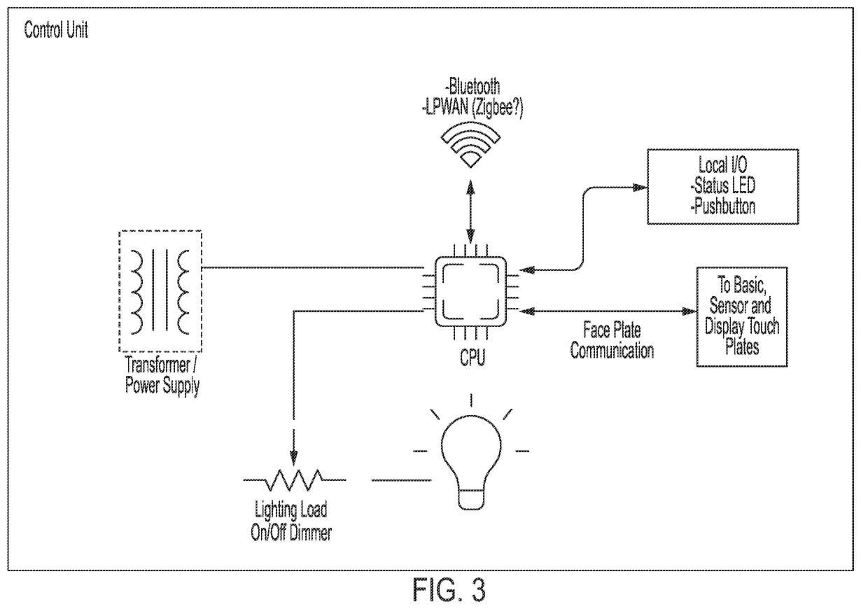

FIG. 3 illustrates an example schematic of one or more techniques described herein.

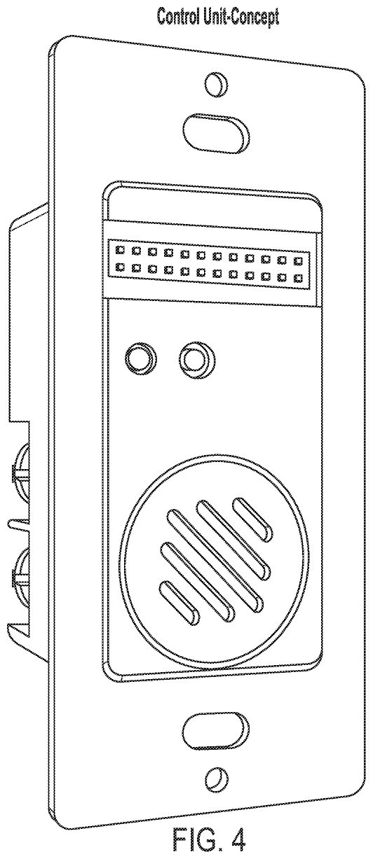

FIG. 4 illustrates an example illustration of at least one input/device that may be used with one or more techniques.

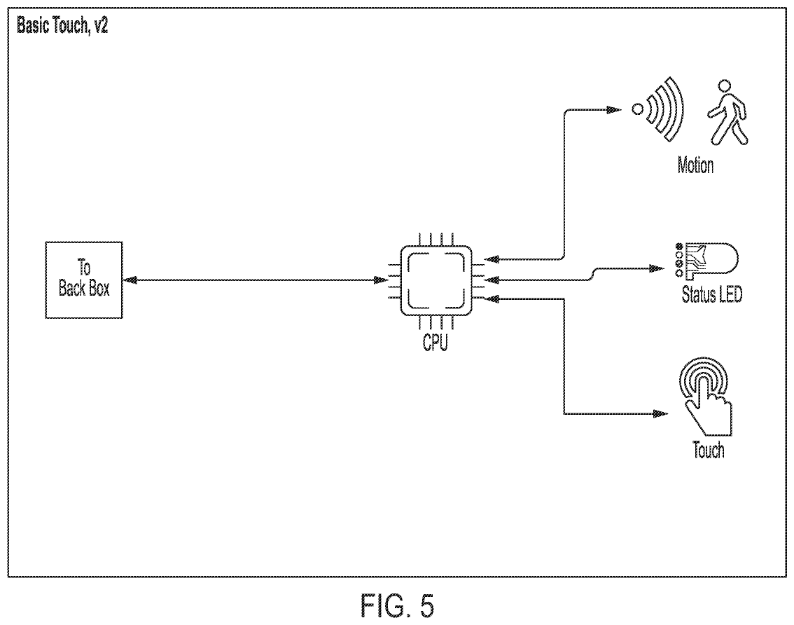

FIG. 5 is an example schematic of one or more techniques described herein.

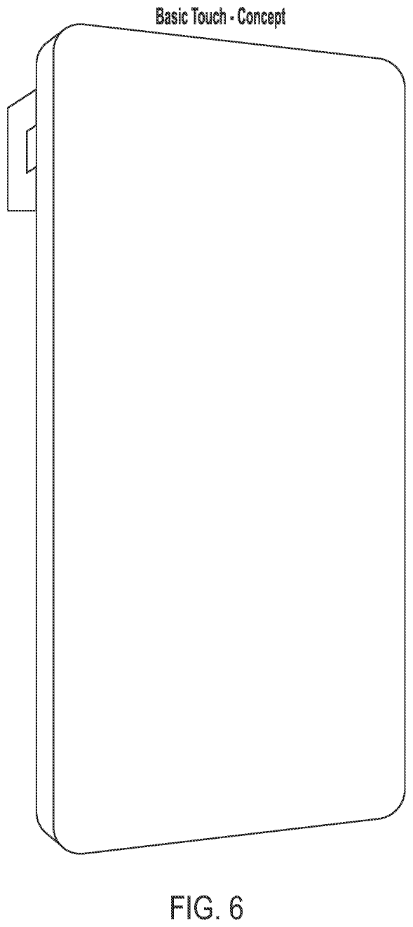

FIG. 6 is an example illustration of at least one input/device that may be used with one or more techniques.

There are three levels of device being offered: Basic Touch, Sensor Touch, Display Touch. Each device is connected to a 120v power supply and is modular in design and similar in size and shape to a standard lighting switch plate. The device includes a fixed base (e.g., Control Unit/Processor), user removable input/output faceplates and has multiple functional capabilities.

The Basic Touch unit consists of a capacitive touch faceplate that fits over an existing light switch cover (name) and connects to a Control Unit/Processor that is housed behind the wall in the space that a standard lighting switch box would normally exist.

The Basic Touch unit contains one or more of the following functional capabilities:
Light dimming and adjustment;
Capacitive touch response removable input/output faceplate;
On/Off switching;
Multiple-switching connectivity (3-way, 4-way);
Faceplate contains ‘RGB’ light emitting diodes (LEDs) to denote system status condition;
Ohmmeter sensing capability to monitor and report current usage or load;
Can be linked to other devices (third party);
Replaces and/or integrates with existing light switches;
Short-term internal power storage capacitance to allow for UPS (uninterruptible power supply) system support;
May be voice activated, perhaps for example including a device mic and/or speaker;
Can re-broadcast Wi-Fi or other content;
Can be integrated with MESH network for at home system networks;
Can accept gestures to enable control features such as music, lights, etc.; and/or
Can be accessed via external mobile interface

FIG. 7 is an example of one or more techniques described herein.

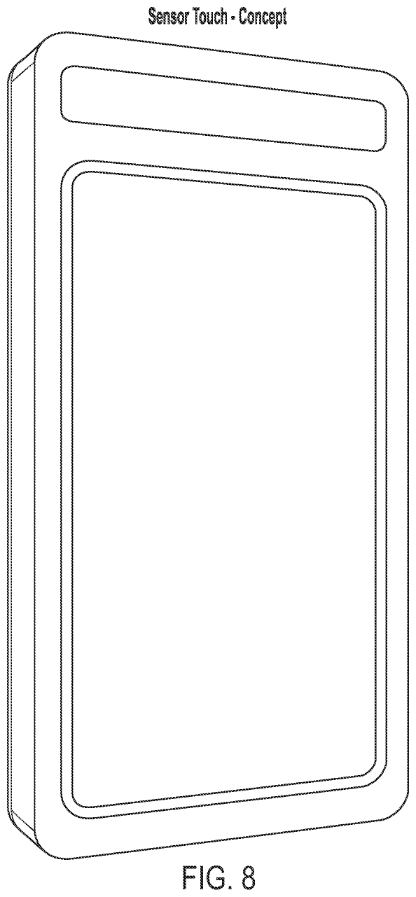

FIG. 8 is an example illustration of at least one input/device that may be used with one or more techniques.

The Sensor Touch unit contains one or more, or all, of the components and features of the Basic Touch unit and adds one or more of the following components and functionality:
Utilizes multiple RF Spectrum signal detection capability including Wi-Fi, Bluetooth, ZigBee and other frequencies utilized to determine the user's orientation to the device using proprietary triangulation software algorithms;
Motion sensing capabilities;
Gathers information from sensors which can be sent to a software processor for further analysis and system action;
Path lighting from bottom of device;
Illumination feature to light a pathway such as in a hallway or stairway;
Utilize RGB technology to provide user feedback;
Connected or disconnected by the user;
Ultrasonic audio capability to build time of flight models, physical environment models, topology of home and and/or location of other devices; and/or
Control Unit/Processor can sense (recognize) changes in accessory piece (faceplate) and auto-configure the system for it.

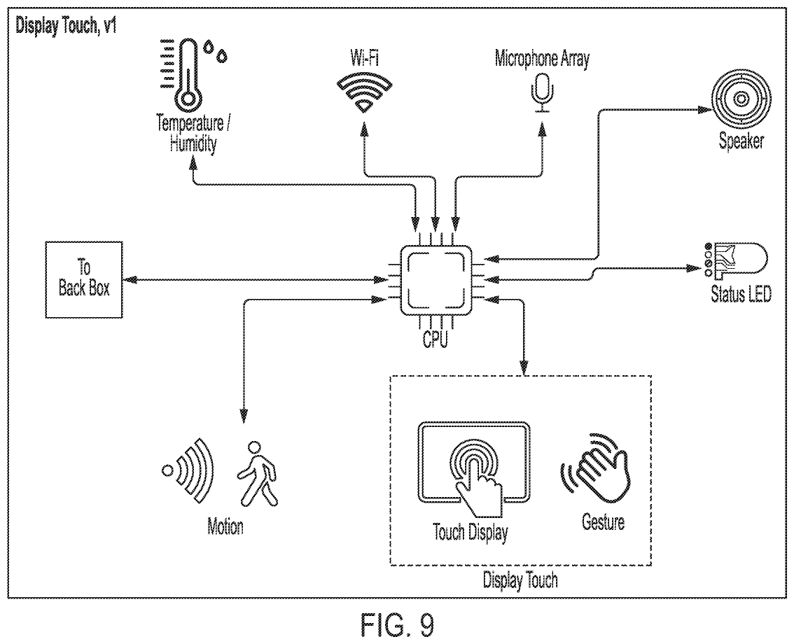

FIG. 9 is an example of one or more techniques described herein.

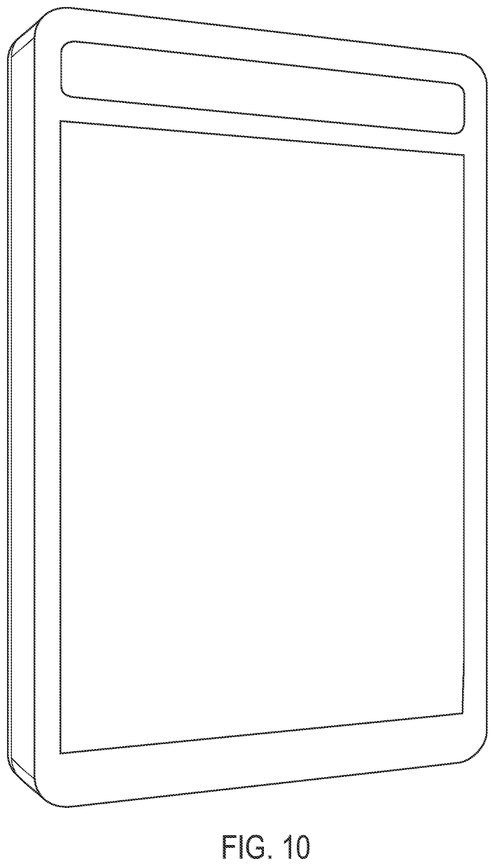

FIG. 10 illustrates an example illustration of at least one input/device that may be used with one or more techniques.

The Display Touch unit contains one or more, or all, of the components and features of the Basic Touch plus Sensor Touch units and adds one or more of the following components and functionality:
Touch interactive full-motion video screen capable front faceplate;
Used to display a GUI (graphical user interface) with any type of user feedback that is either received, processed, or analyzed by the system and can provide Insights' through the device;
Can be used with or without a Hub (wired or wireless) to connect to other devices;
Can be integrated with an existing home network;
Creates primary devices that connect through a WAN (wide area network);
Can also serve as a light fixtures and/or may be incorporated into a light fixture (e.g., such as a replacement for a can light); and/or
All other devices connect only through a LAN (local area network).

There may by one or more (e.g., unique) input and/or output to the algorithm. There may be one or more Training Dynamic Automation (Learning Models):
Identifying user intent based on individual environment events;
To update, create or append a particular rule that is currently running, or not currently created; and/or
Machine learning modifies the programming on end-point devices.

There may be one or more Machine Learning models that run locally, even without internet connectivity. There may be Sensor-stream meta data.

There may be Audio signature ID recognition. Ability to recognize a sound in the environment and associate an action when that sound has triggered.

There may be Software distributed ledger encryption, for example In-network evaluation of the ledger.

There may be In-home user [geo]location:
Using multiple confidences (voice, device location, motion detection); and/or
Determining topology of one or more (e.g., OMNI) Home Automation devices using Time of Arrival [TOA] (audio and RF).

There may be device triangulation and/or trilateration:
And using this as an input to the Machine Learning algorithm; and/or
Adjusting what is displayed on the mobile app based on the devices location.

There may be Yes/No user input ties directly into the Machine Learning training data. There may be Complete Voice Configuration, including transmission of credentials as audio to the device.

There may be a transfer of content, profiles, etc. from room-to-room as a device/user moves throughout the house. For example, a user's lighting preferences follow them throughout the residence. For example, information (e.g., messages, multimedia, and/or content, etc.) that may follow users throughout the residence.

There may be a display of only necessary data (and controllable devices) on the mobile app based on relevance as determined by ML (e.g., one or more, or all inputs including location).

There may be a use of a combination of sensors (accelerometer and microphone) to measure, identify health and alert a user of system status of ‘mechanical’ systems (e.g., a/c, washer/dryer, refrigerator). There may be other use cases that may gather sensor data, for example to determine a status of users (e.g., health and/or identification, etc.).

There may be use of calendar data to run in-home systems (lights, security system, etc. when you are away), such as:
Vacation mode for lighting (random on/off times); and/or
Predictive HVAC.

There may be data obfuscation (misinformation) for system security. There may be a stream of data that comes out of the home that may be in a completely unique format that is never devisable again. There may be devices that self-configure as front faceplates are interchanged. In addition, you can change the features and usability of the device (e.g., and/or capabilities of the light switch).

There may be one or more unique product designs. The Product Design may include Snap-on/modular front face design.

There may be one or more all-in-one solutions for single, 3-way, 4-way switching, and including software enabled/disabled dimming. This may include monitoring power on multiple inputs to determine n-way switching mode.

There may be one or more home automation systems (e.g., entirely) housed in one or more light switches (e.g. WiFi access point via the switch location device). There may be integrating of the path-light into the light switch (e.g., using ubiquitous motion sensors as predictive controls). There may be interior pet fencing capability (e.g., using sonic frequencies as deterrents).

There may be one or more System Software Architectures. The device can gather information from the local switch sensors, mobile device sensors, Cloud or servers and send it to the CORE for system processing. The system can take several actions, such as for example, self-healing, load balancing, and/or redundancy. For example, the CORE may be virtual and/or can be located on any of the devices (e.g., OMNI devices) in the system.

There may be Immediate Action. The software can cause the system to respond in a variety of ways based on the analysis of the input, for example: Turn lights on/off, dim lights, adjust temperature, trigger alarms, etc.

There may be Time or Date based Action. Based on pre-programmed input, the system can take action based on a specific time or date:
Turn lights on/off, dim lights, adjust temperature, etc.;
Vacation settings; and/or
Can be controlled through internet or mobile interface remotely.

There may be Delayed Action, for example Pre-programmable capability for events at later times.

All sensor data is used to provide a dataset for conventional actions based on IF THEN, AND, AND, OR.

The system analyzes streams of metadata (to/from cloud) for machine learning (AI) to enable actionable patterns or to take appropriate action.

Store information in machine learned patterns for comparison to patterns to add new learned patterns.

Programmable by the user based on stored thresholds which can be changed through a user interface.

Machine learning provides questions to the user such as, for example: Is this (e.g., condition, action) correct? YES or NO.

Places the user in the feedback loop may be based on the answers to the questions. One or more answers may provide some of the actions that get stored to be executed (e.g., creates a pattern), for example: The pattern then becomes a macro to perform the specified action (e.g., turn on a light).

Feedback answer response gets built into a program to take action, but also adds it to the machine learning side, specifically the training set, and/or revising the learning based on responses.

The process of updating the machine learning (training) based on simple user interactions is the central aspect of the software.

Shifting the user experience from the current state where the user initiates an action, to a new state where the system initiates the action based on a learned response or validation from the user.

There may be System Security. The security of the system uses a distributed ledger (e.g., Blockchain) method to validate the software. Such validation may include one or more of:
Check ledger does NOT match=Dog vs. Bat;
Isolate errant device(s);
Analyze errant device for troubleshooting to determine cause; and/or
Notification(s) sent to system CORE.

In one or more scenarios, one or more techniques and/or devices may be used (e.g., entirely) without cloud services, perhaps for example so that no user data may be useful (e.g., required) to be sent outside the physical structure. System security via a distributed computing structure may permit that no user information may leave (e.g., may need to leave) the LAN. Distributing computing may allow for individual “nodes” (e.g., control units, sensor touches, and/or display touches) to be upgraded via replacing the hardware and/or can be auto configured into system.

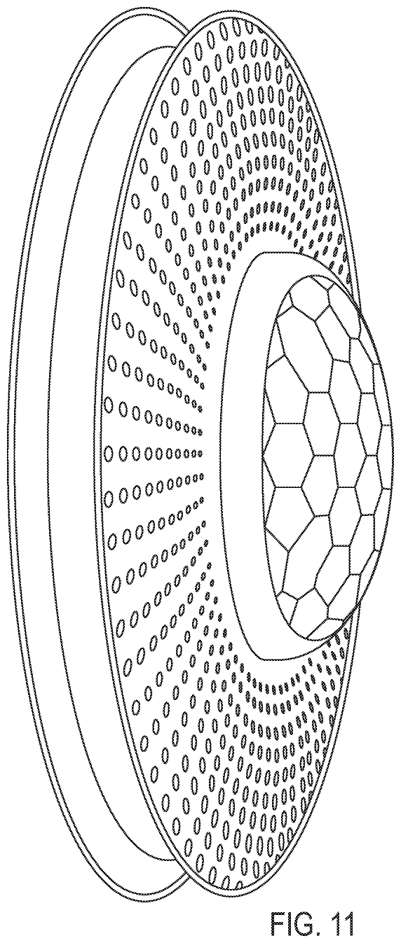

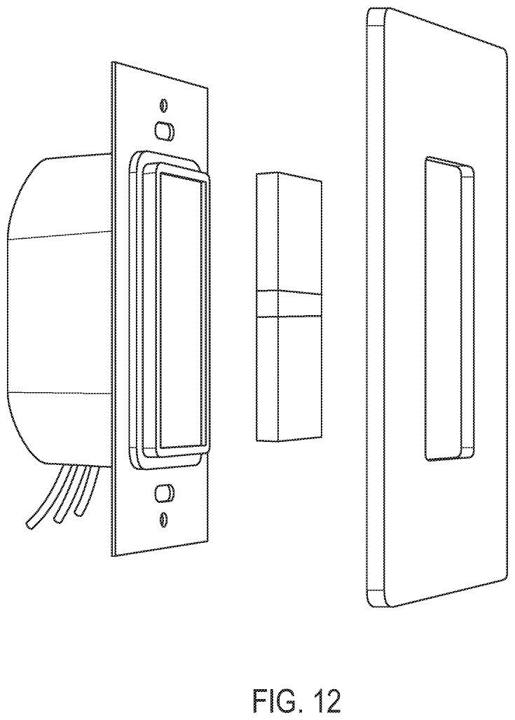

FIG. 11 is an example illustration of a ceiling sensor package/smoke detector.

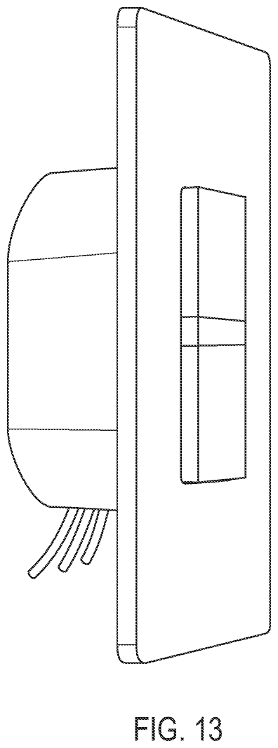

FIG. 12 is an example illustration of an exploded sensor touch light switch.

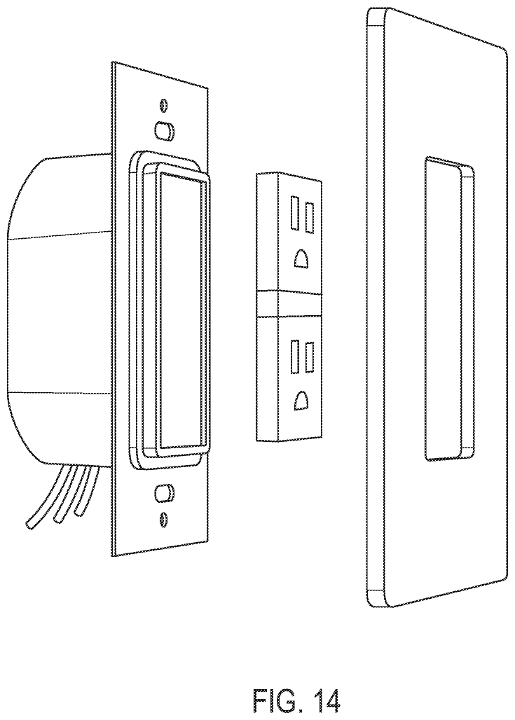

FIG. 13 is an example illustration of an assembled sensor touch light switch.

FIG. 14 is an example illustration of an exploded sensor outlet.

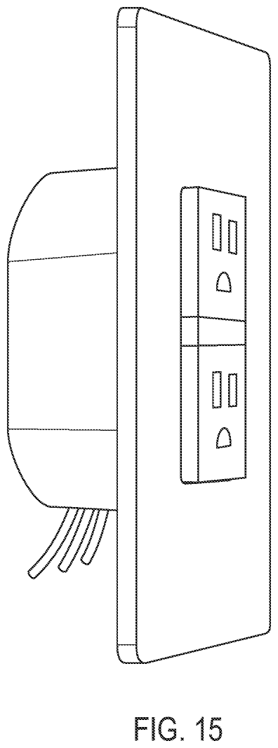

FIG. 15 is an example illustration of an assembled sensor outlet.

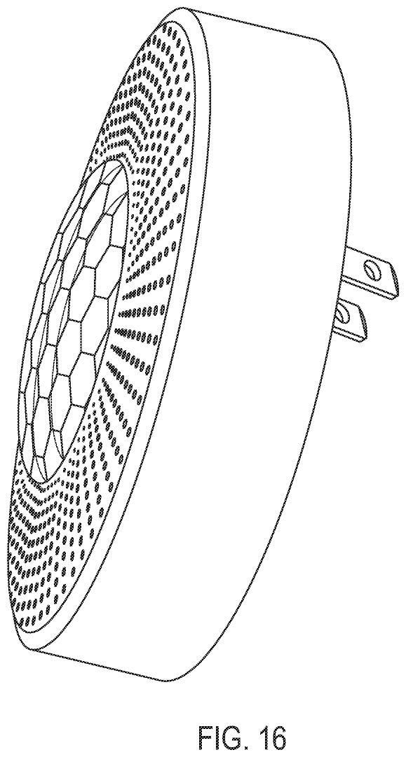

FIG. 16 is an example illustration of an sensor outlet.

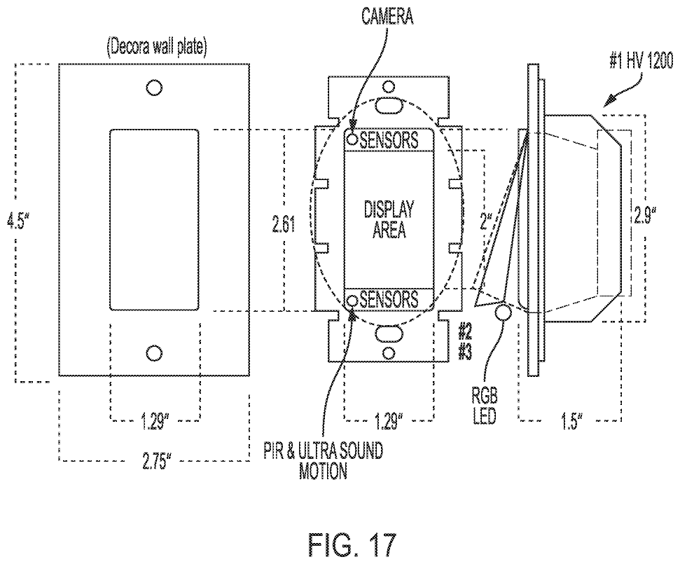

FIG. 17 is an example illustration of an alpha-string button assembly.

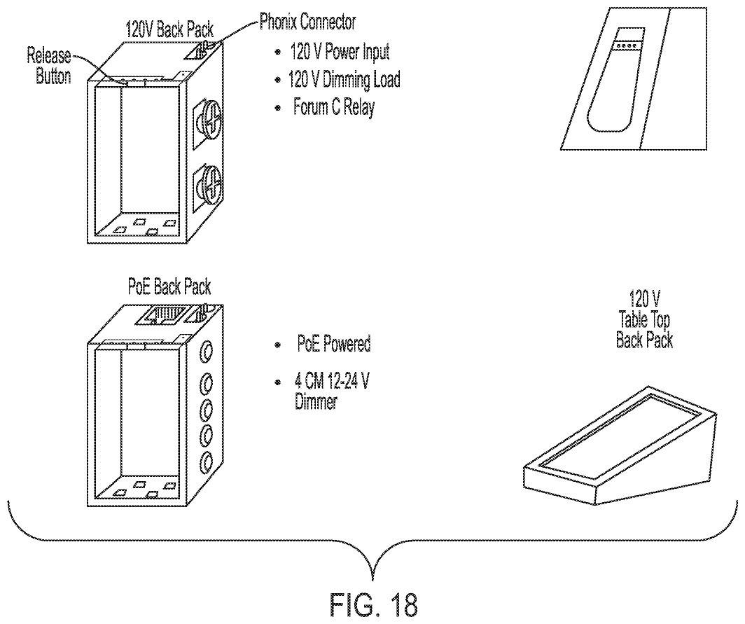

FIG. 18 is an example illustration of a backpack assembly.

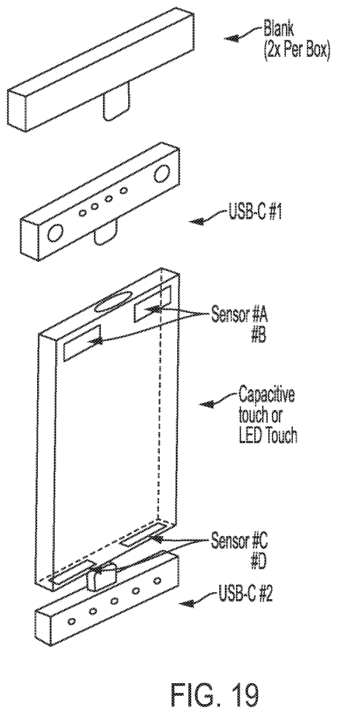

FIG. 19 is an example illustration of a camera add-on assembly.

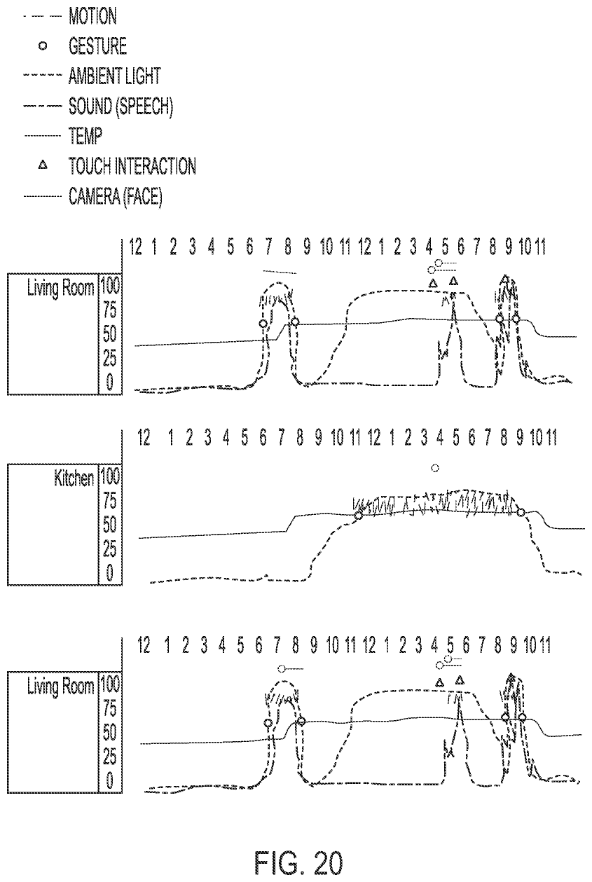

FIG. 20 is an example illustration of a control system dashboard.

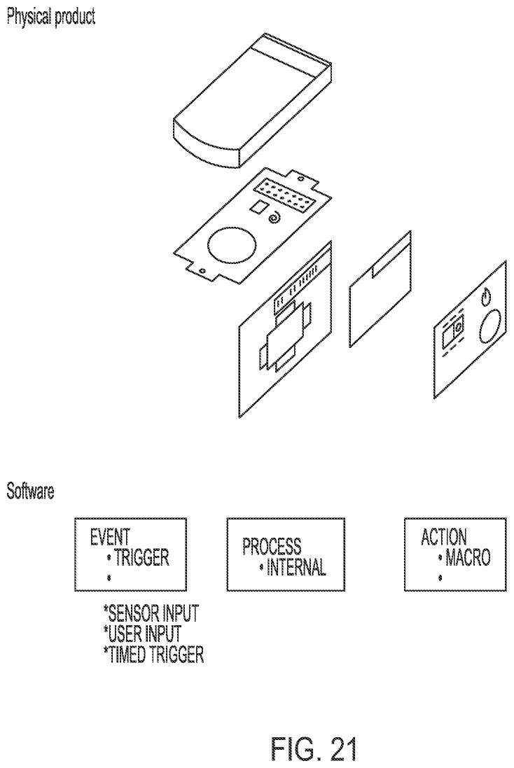

FIG. 21 is an example of control system definitions.

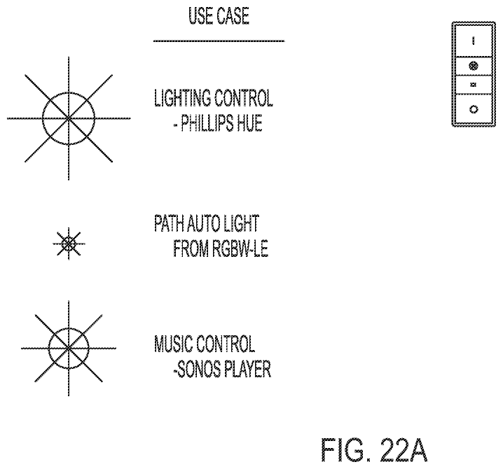

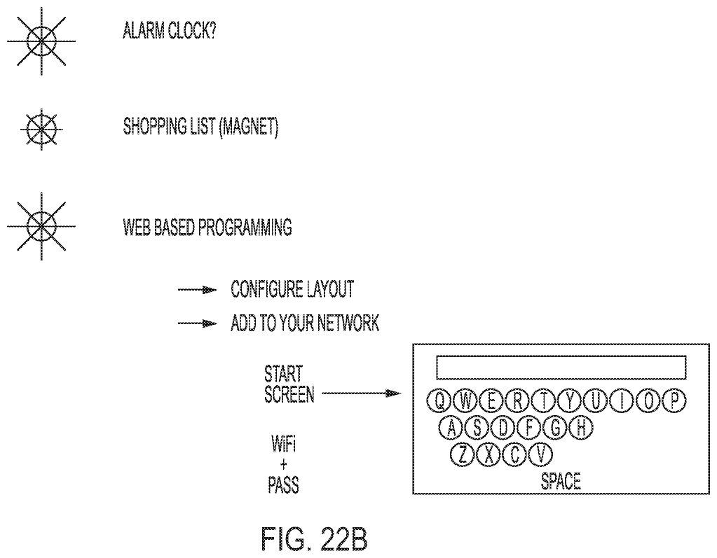

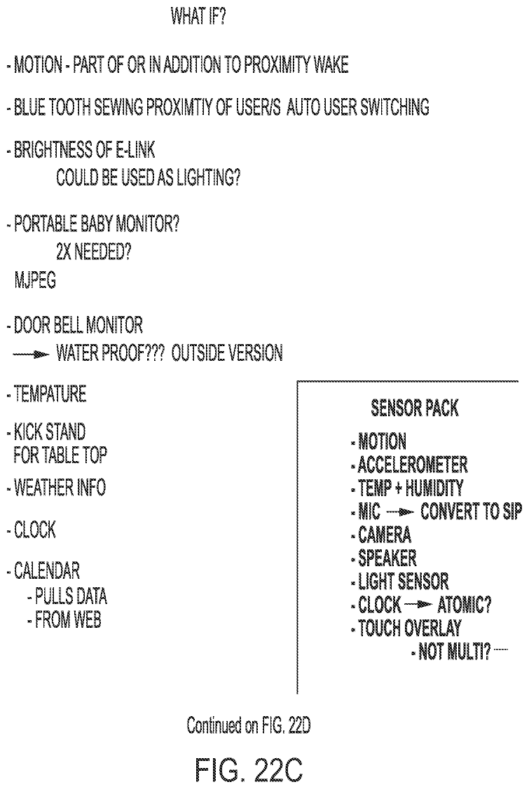

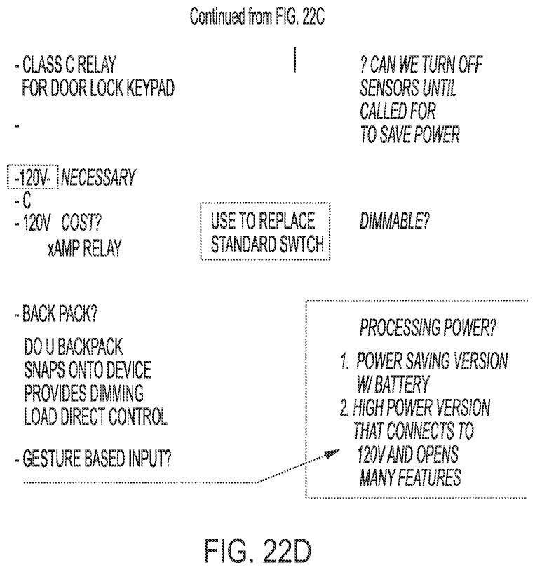

FIG. 22A to FIG. 22D is an example illustration of an e-button assembly and configuration.

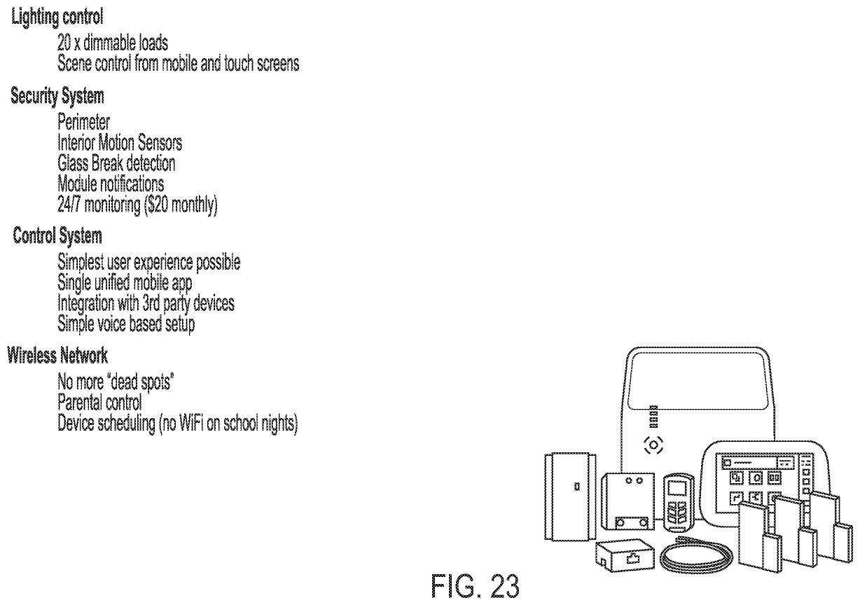

FIG. 23 is an example illustration of an executive overview of the control system.

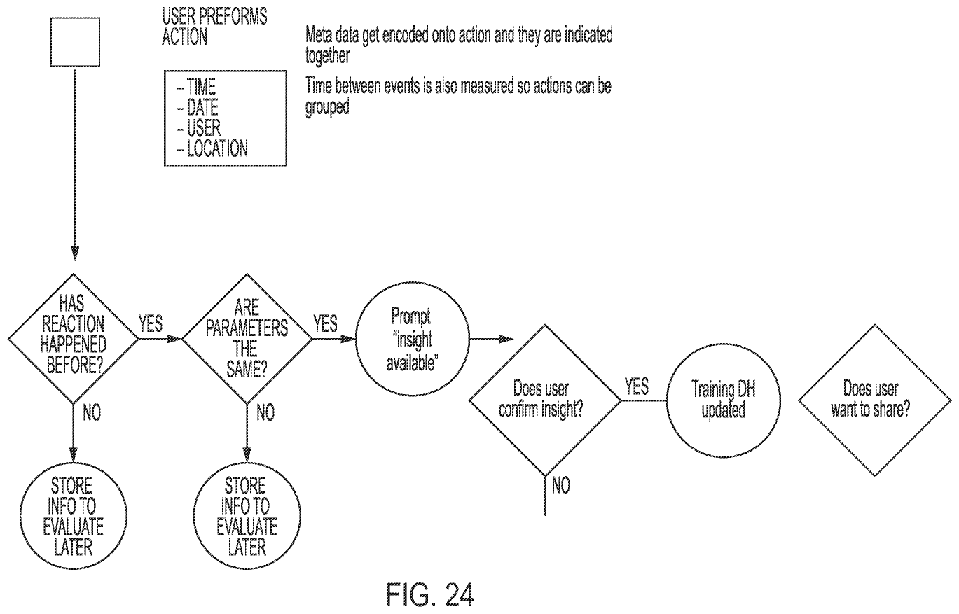

FIG. 24 is an example illustration of a home automation feedback loop.

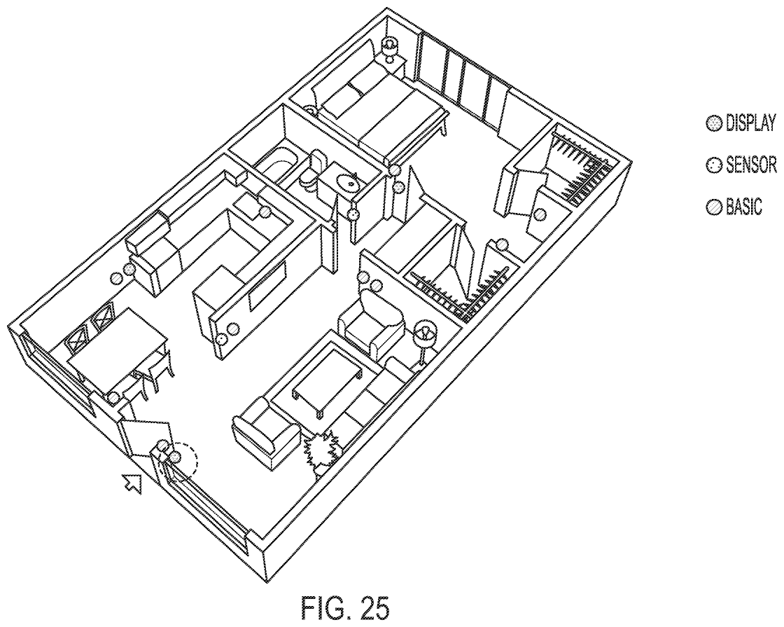

FIG. 25 is an example illustration of a control system deployed in a house.

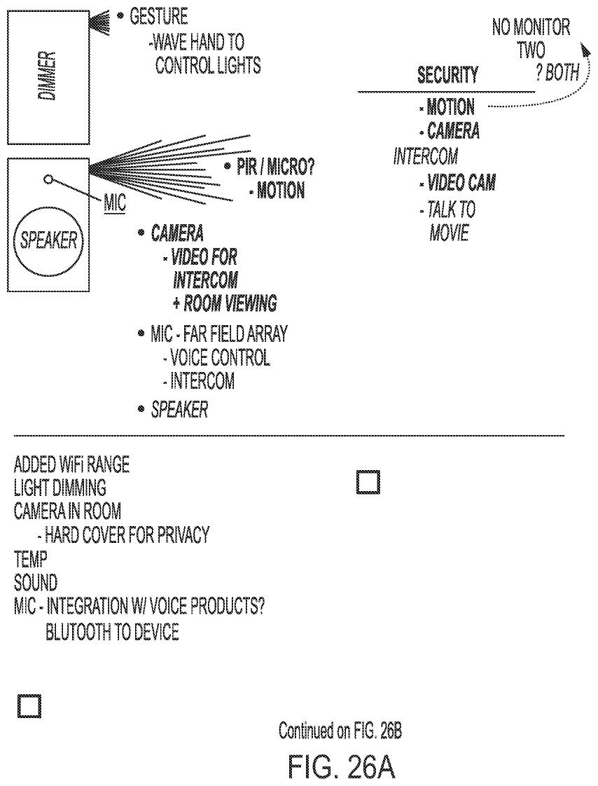

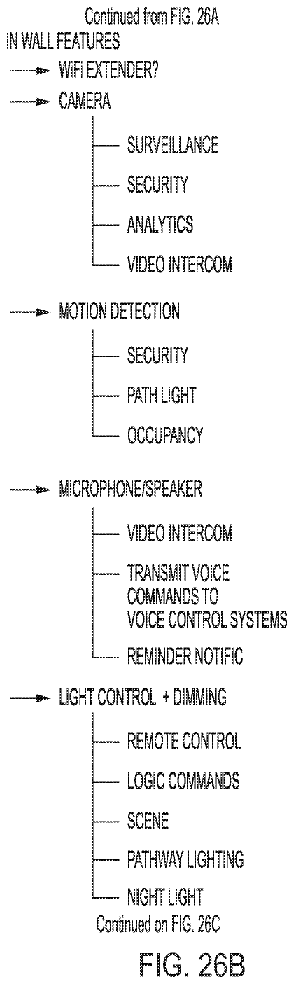

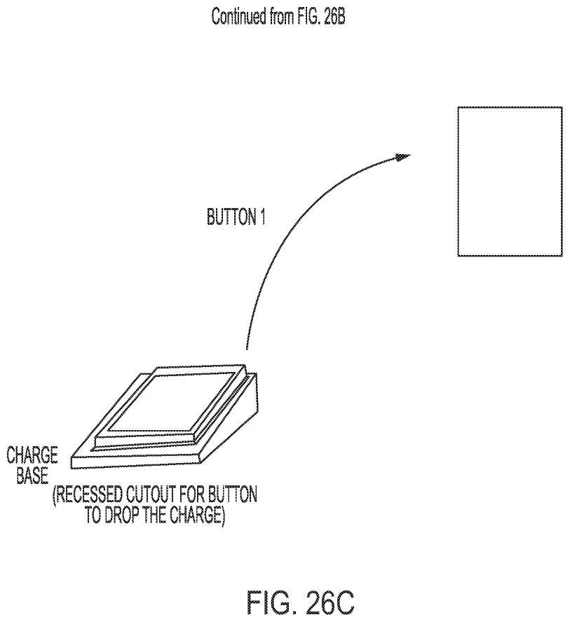

FIG. 26A to FIG. 26C is an example illustration of an in-wall dimmer full device.

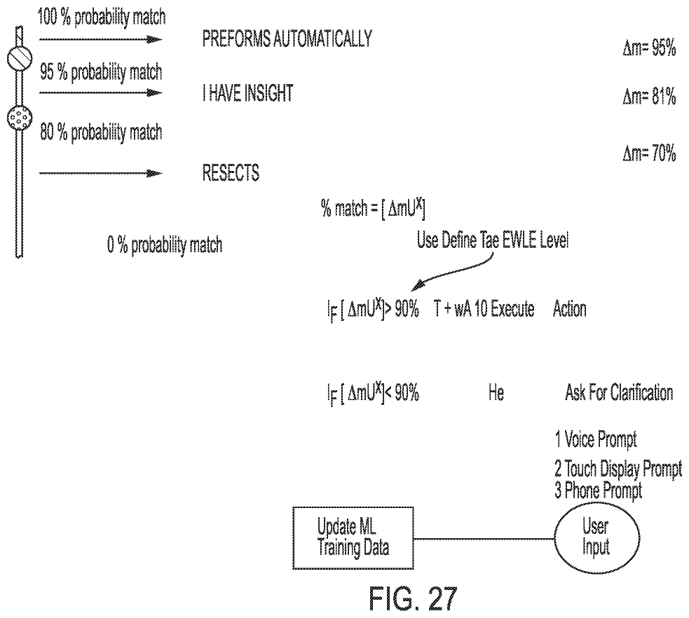

FIG. 27 is an example illustration of an insight training model.

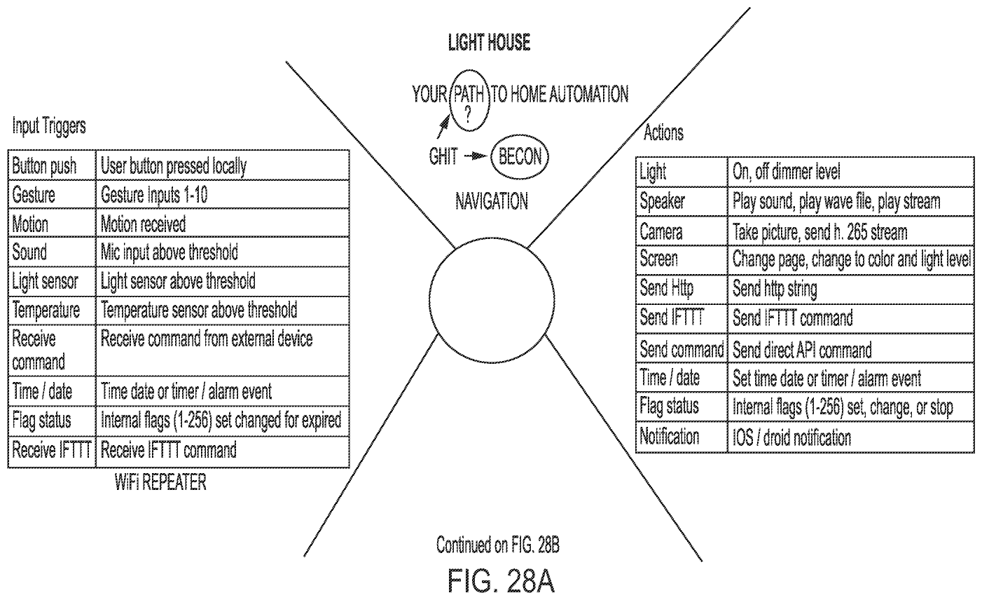

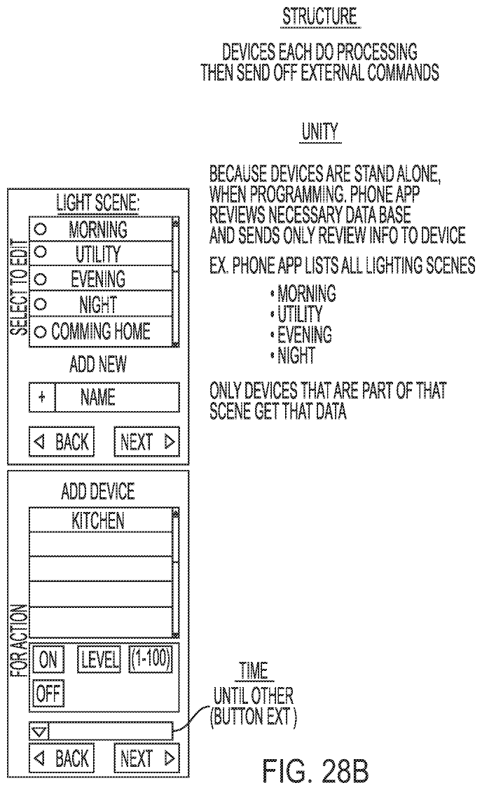

FIG. 28A and FIG. 28B depict example illustrations of a lighthouse model.

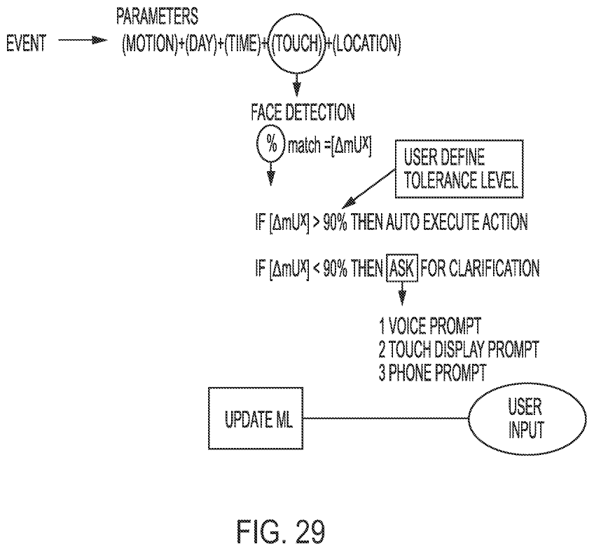

FIG. 29 is an example illustration of an ML system and process.

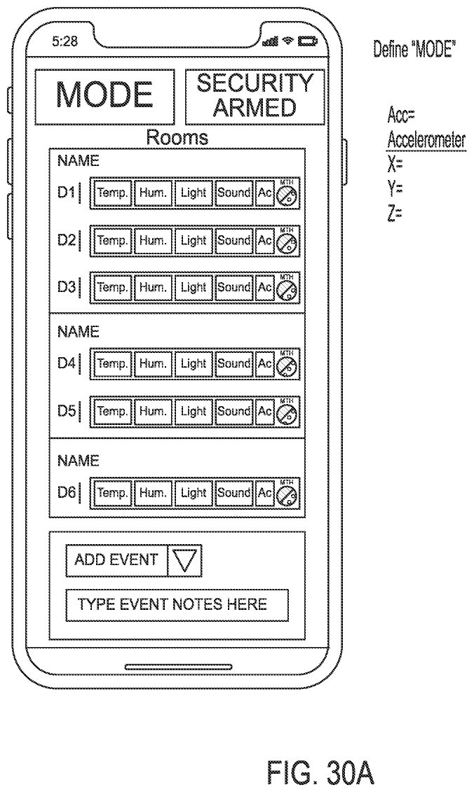

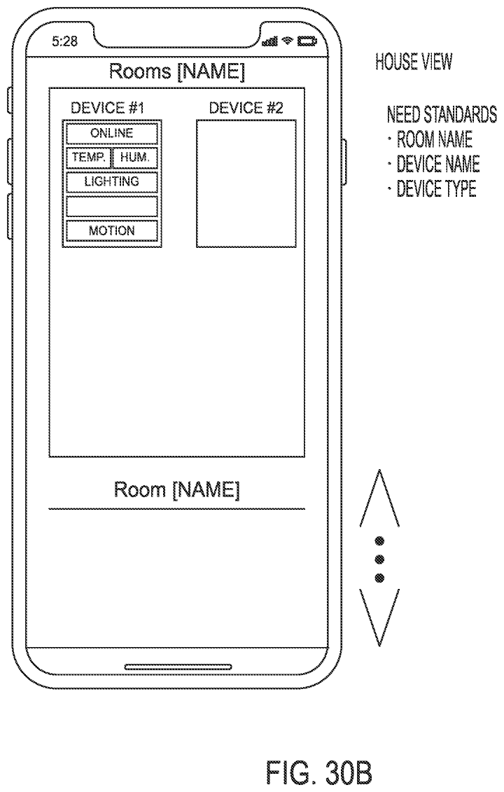

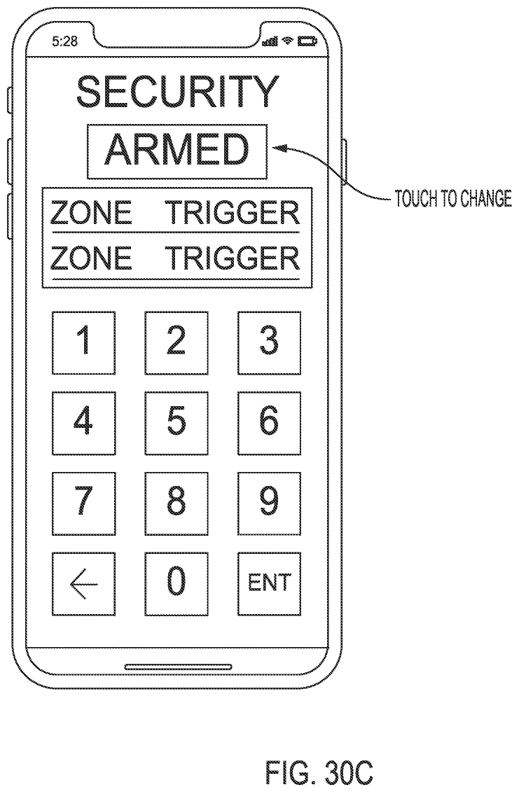

FIG. 30A to FIG. 30C depict illustrations of a mobile interface for the control system.

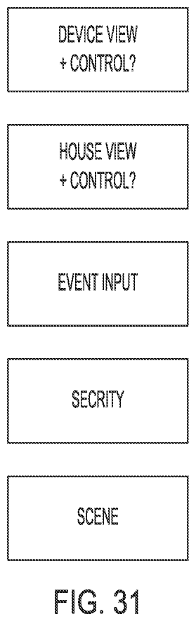

FIG. 31 is an example flowchart of control system programming.

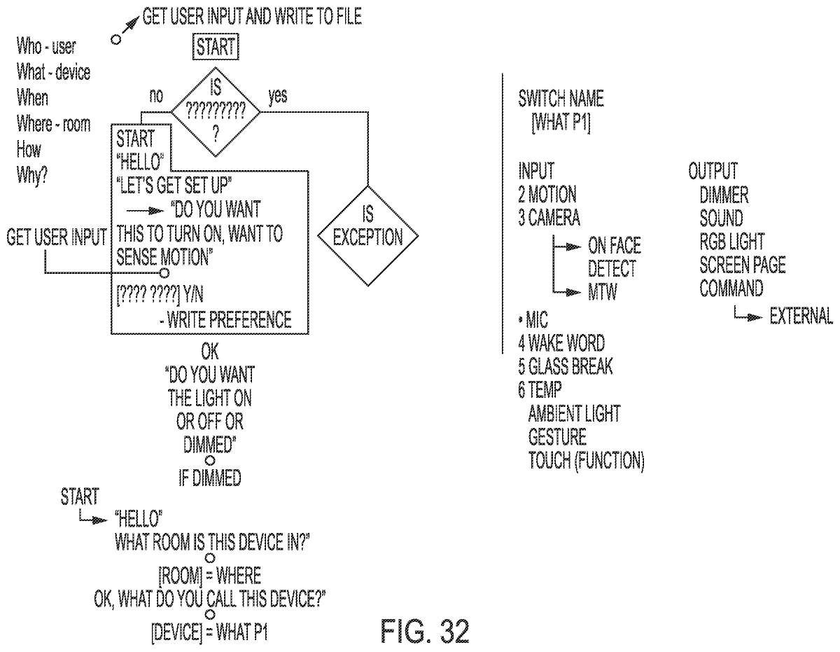

FIG. 32 is an example illustration of control system configuration.

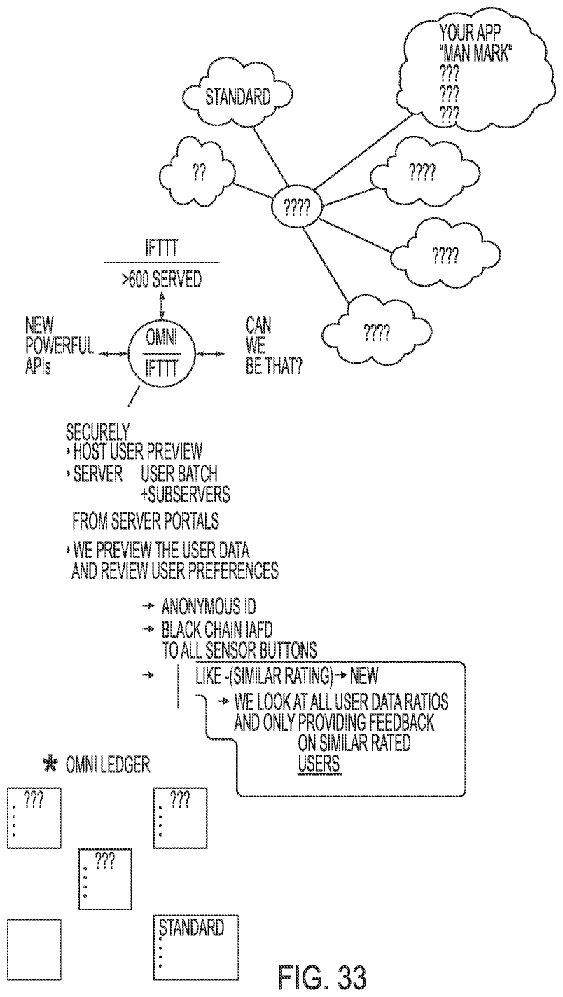

FIG. 33 is an example illustration of an eco-system.

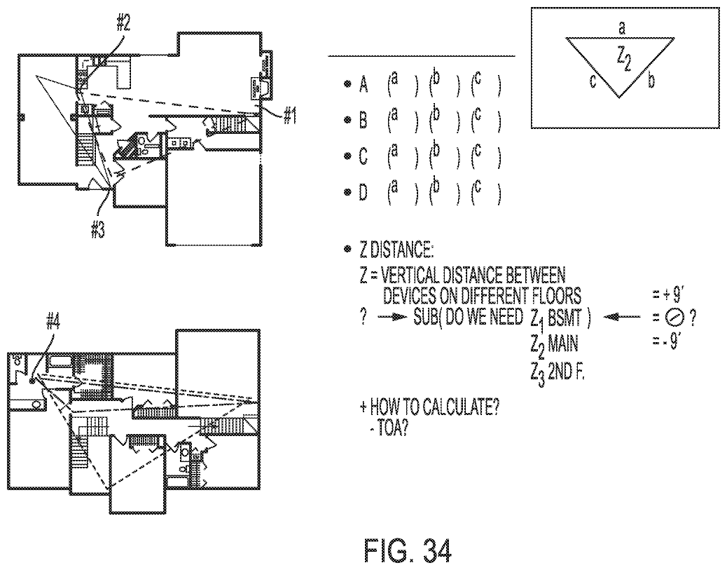

FIG. 34 is an example illustration of a main floor with a control system implementation.

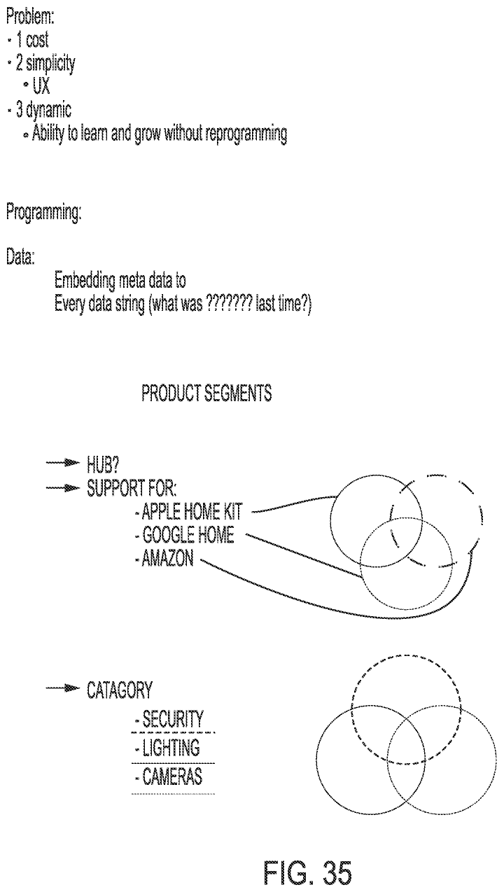

FIG. 35 is an example illustration of a product displacement.

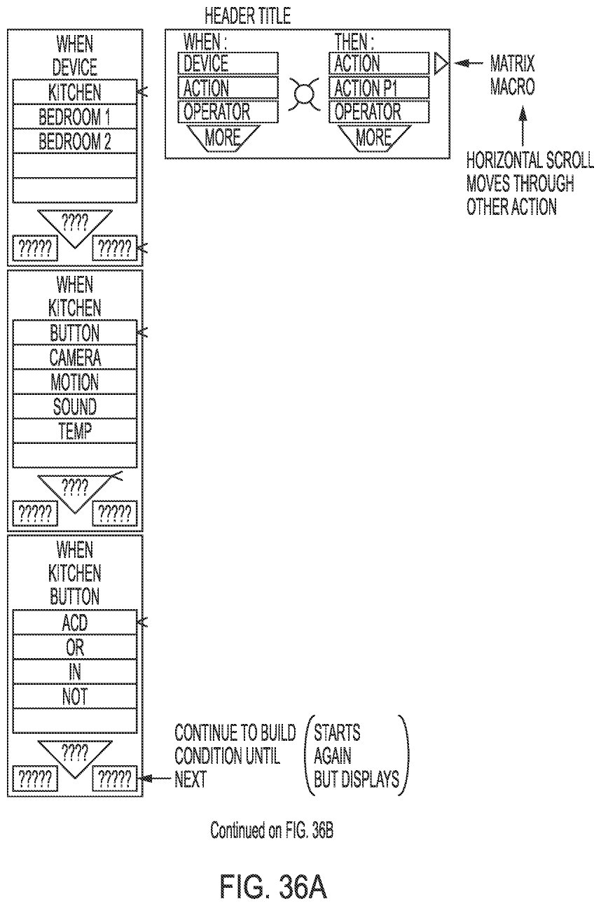

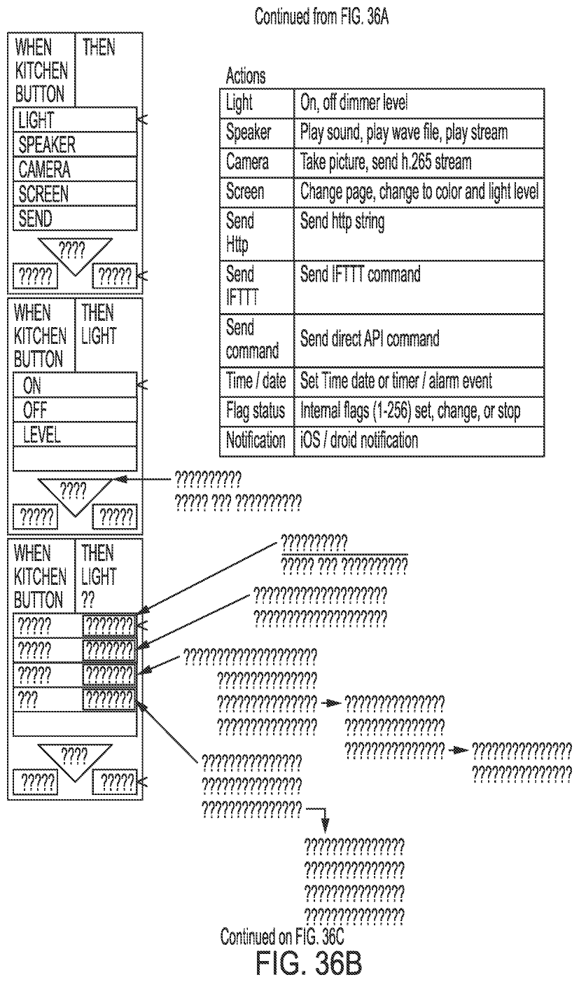

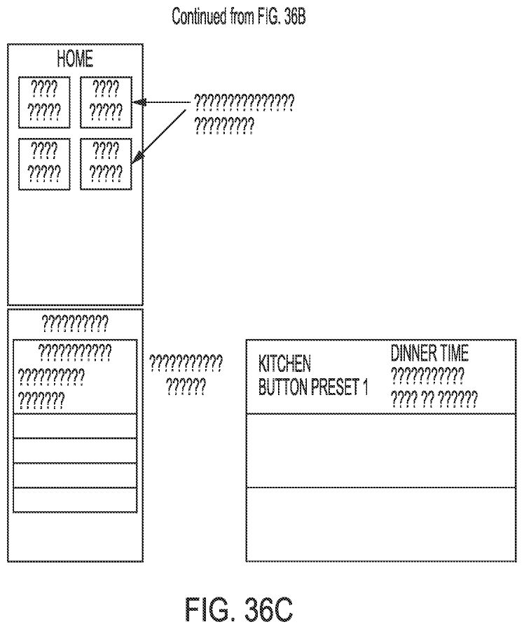

FIG. 36 is an example illustration of programming process.

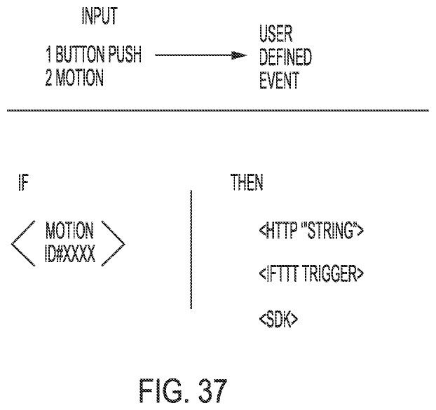

FIG. 37 is an example illustration of server-side configuration for the control system.

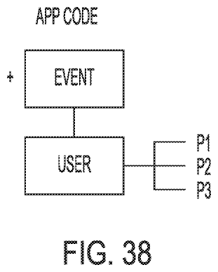

FIG. 38 is an example illustration of control system software.

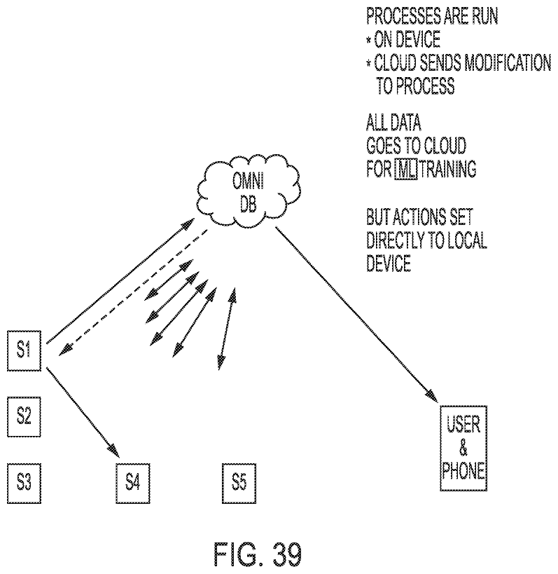

FIG. 39 is an example illustration of control system communication.

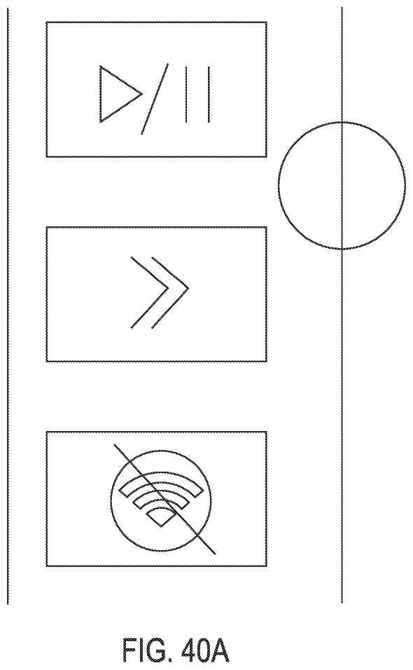

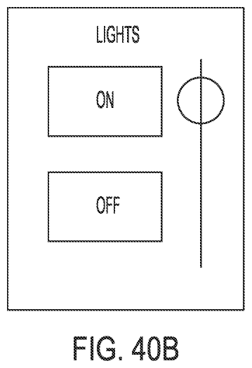

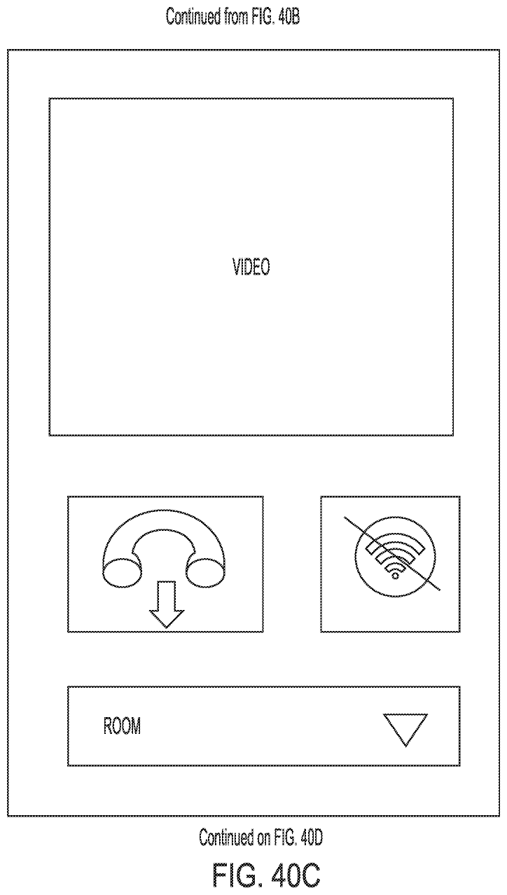

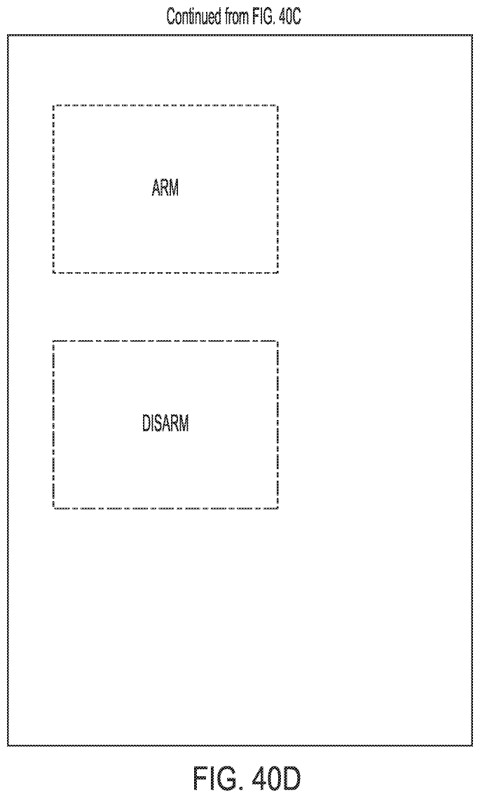

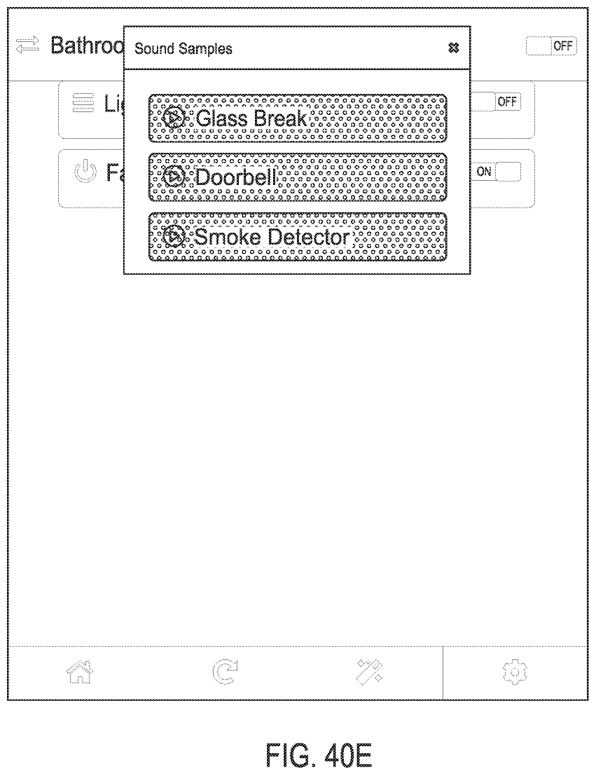

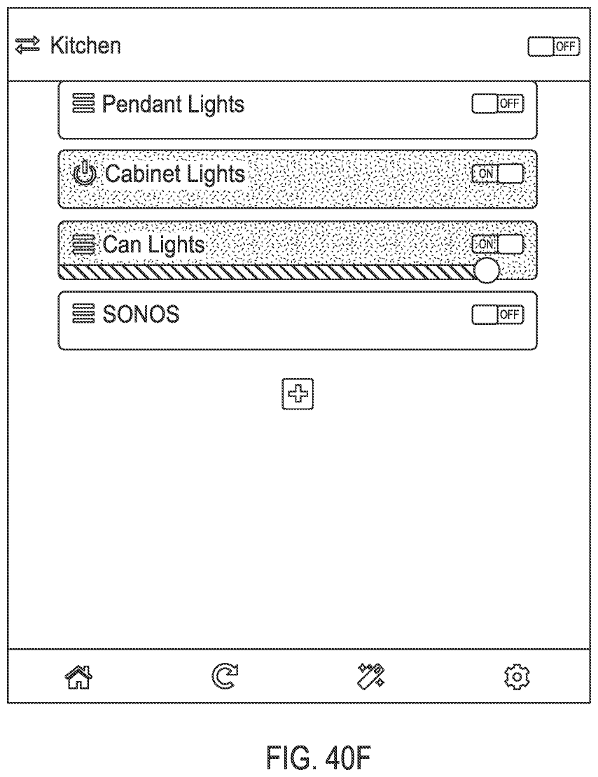

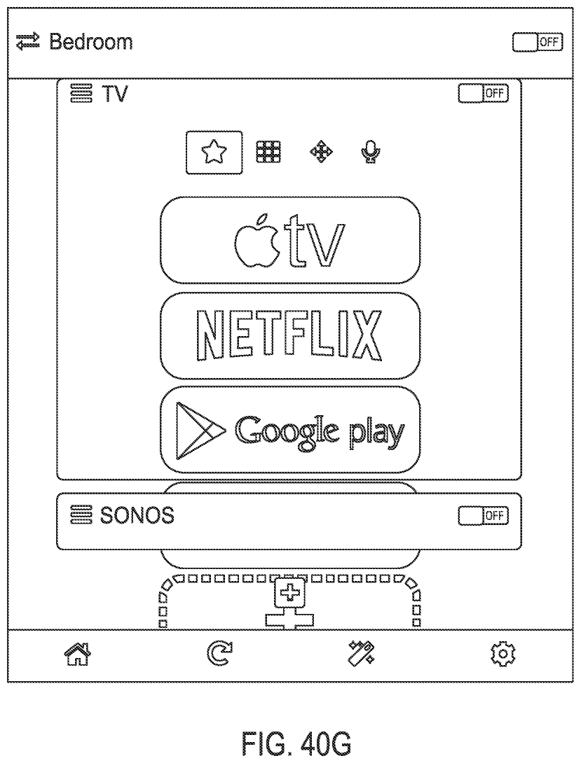

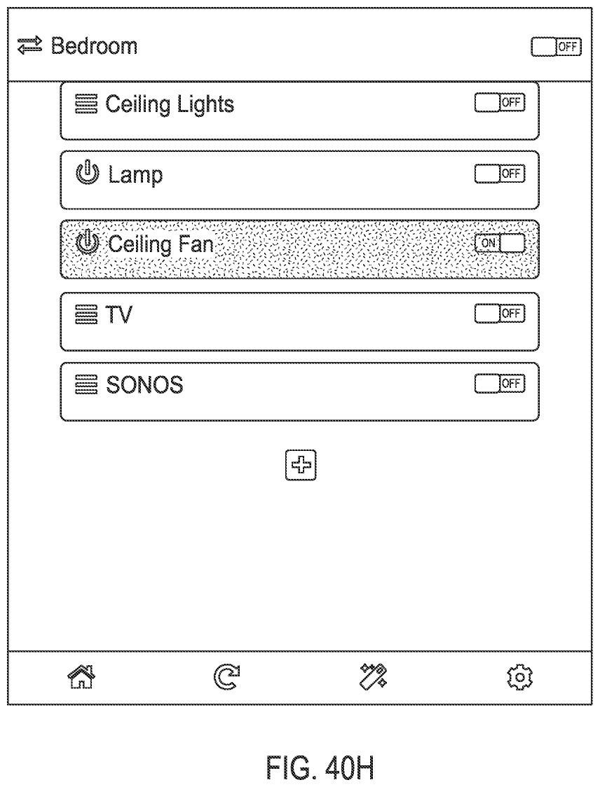

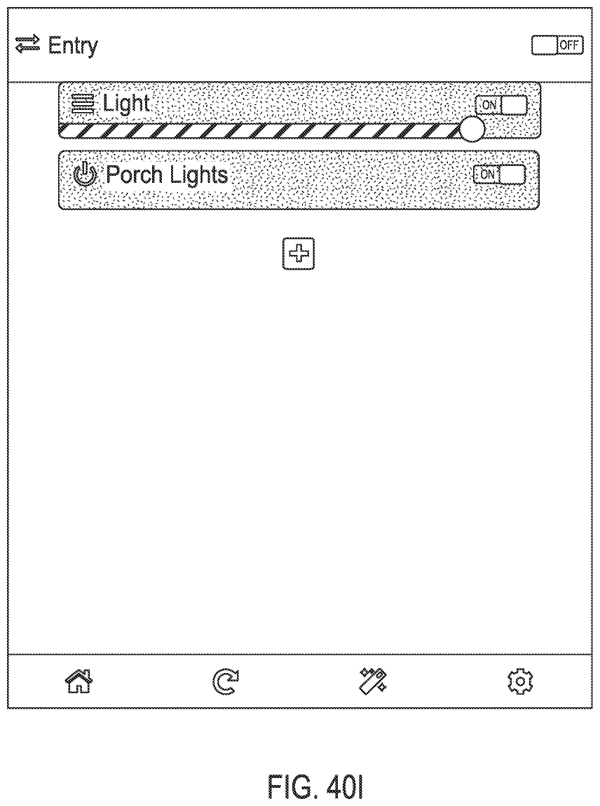

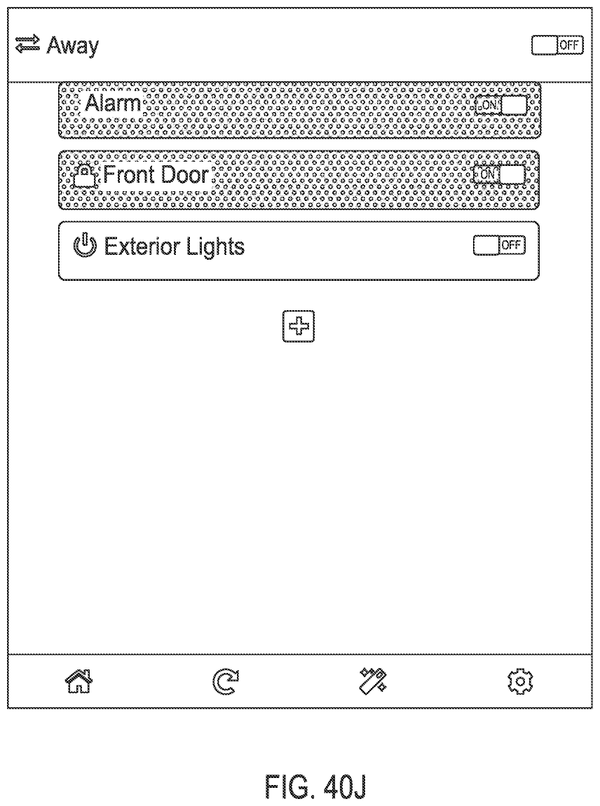

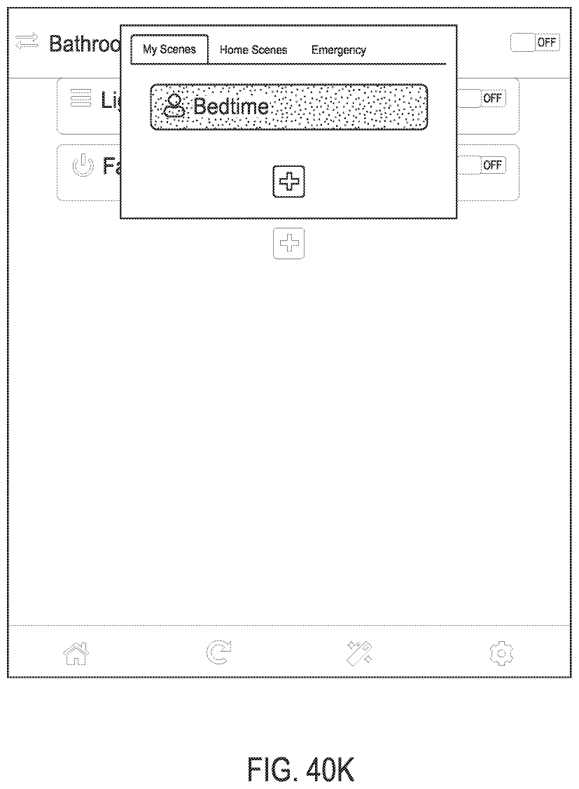

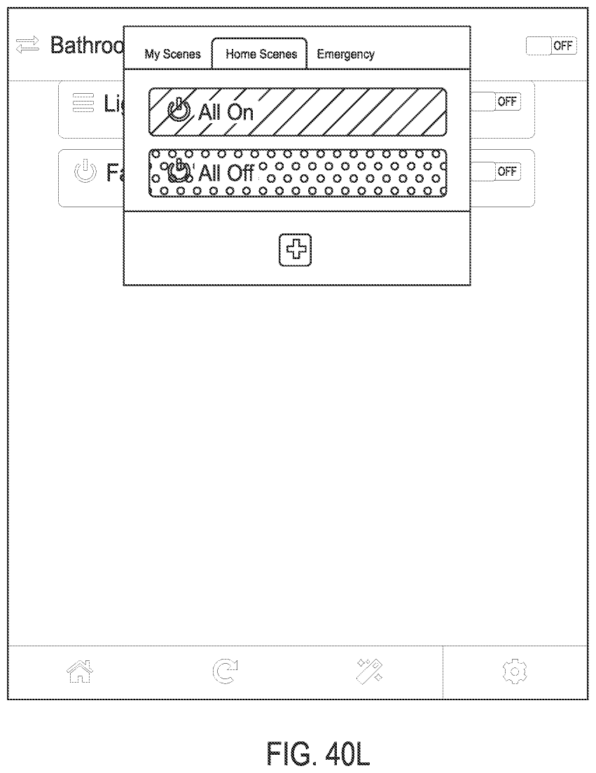

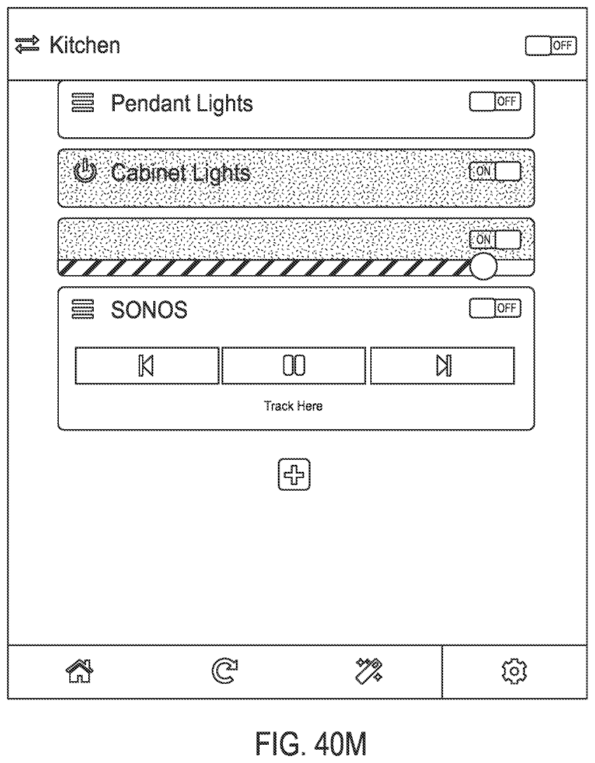

FIG. 40A to FIG. 40M depict example illustrations of templates and/or screenshots for one or more elements of the control system.

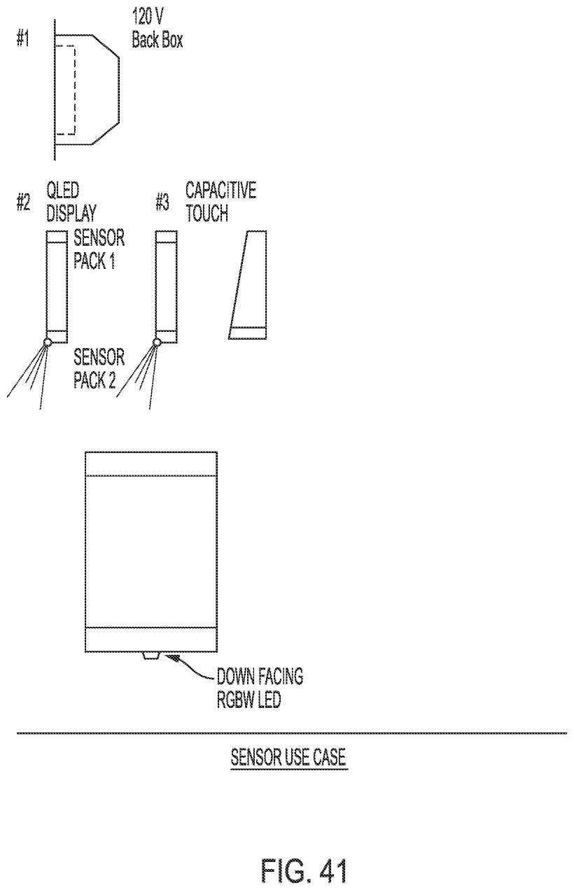

FIG. 41 is an illustration of an example of a configuration scheme for the control system.

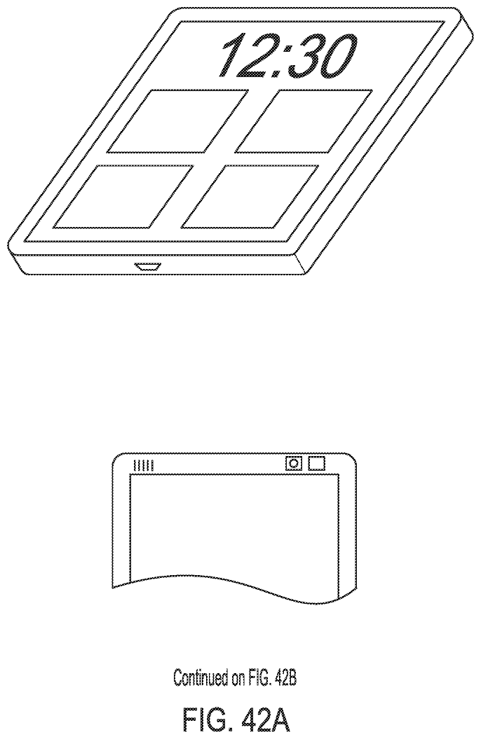

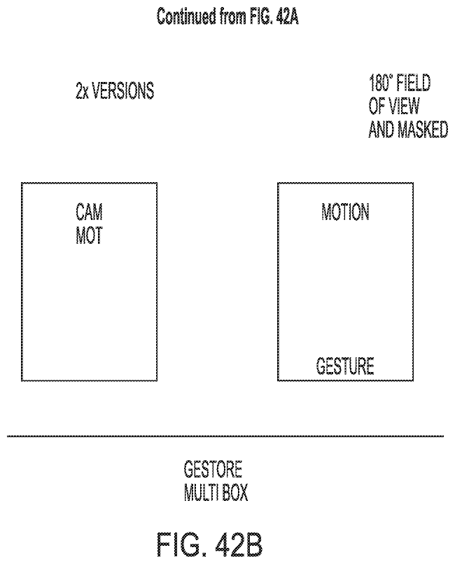

FIG. 42A and FIG. 42B depict an illustration of an example of a configuration scheme for the control system.

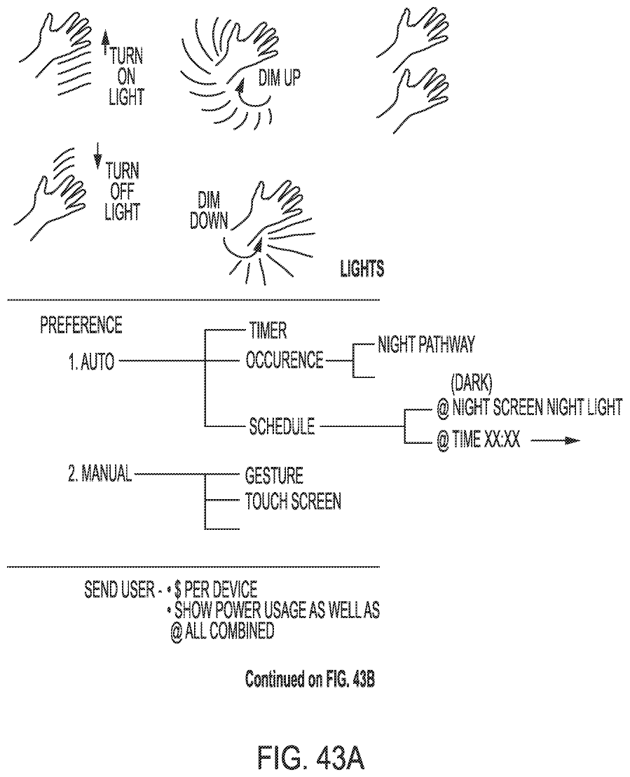

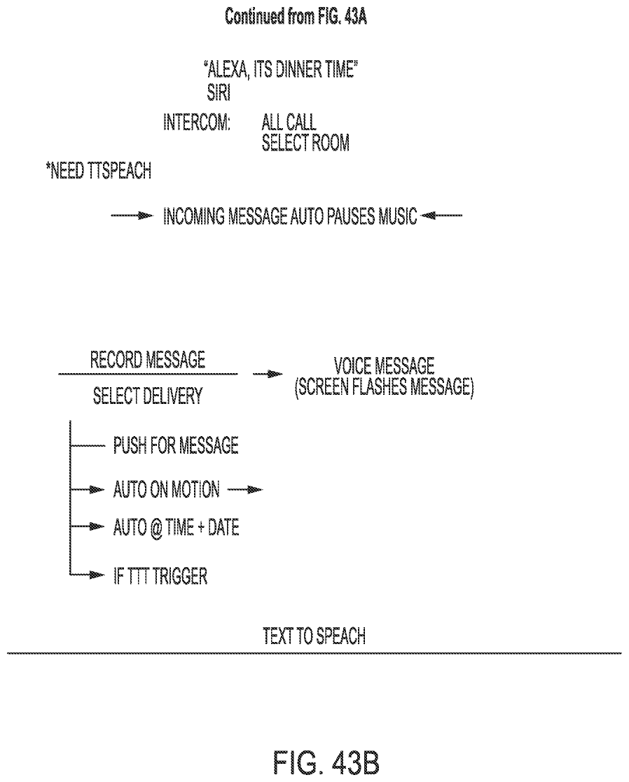

FIG. 43A and FIG. 43B depict an illustration of an example use case of the control system.

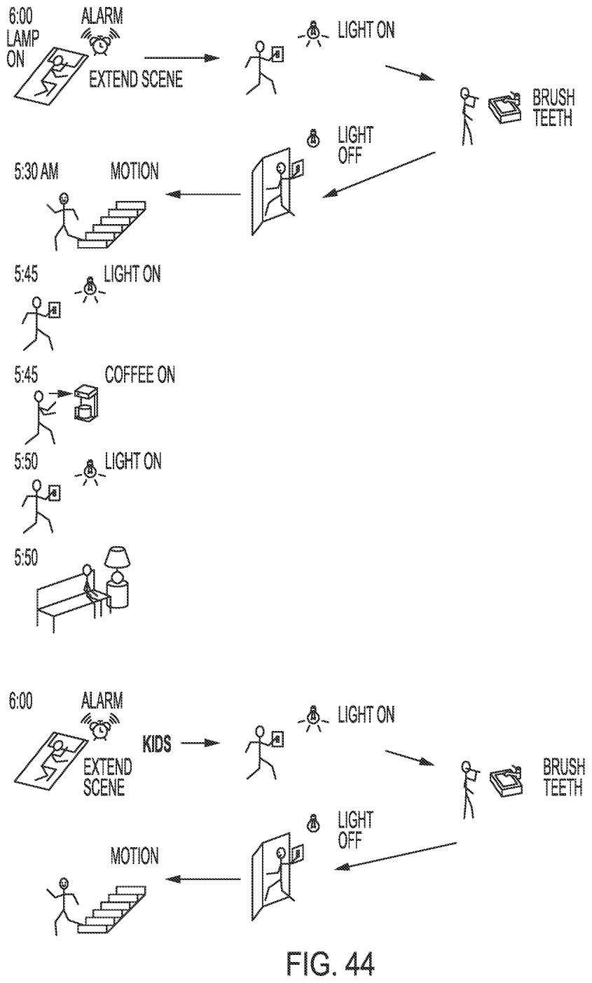

FIG. 44 is an example illustration of an interaction cycle with the control system.

Table 1 lists some functions/attributes of the control system, for example outside a user's home.

TABLE 1

| Control System May Demonstrate | Smart Home Response |
|---|---|
| Show status on app. Door locked, | |
| Security on. When owner arrives | |
| home, at least three things may | |
| be triggered: Unlock door, | |
| disable security, turn on lights | |
| Unlock door (App) | Door unlucks. Security |
| | Disabled. Entry Lights (inside |
| | and out) turn on |
| Show status updates in App | |
| Note that the Smart Home may | |
| recognize who unlocked the door. | |
| The system may sense when the | |
| person enters the home and/or | |
| may provide some audio information. | |
| Enter home. | Personalized welcome plays. |
| | Pet Status provided. Calendar |
| | event announced. |
| The Home may know the person, | |
| via the person's device. The Home | |
| may know the pet's status, because it | |
| may be tracking a beacon on the pet's | |
| collar (e.g., the pet's device). The | |
| Home may access the person's | |
| integrated calendar to remind the | |
| person of a next event. | |

Table 2 lists some functions/attributes of the control system, for example in a family room and/or bedroom.

TABLE 2

| Control System May Demonstrate | Smart Home Response |
|---|---|
| The sensor touch device may detect motion and the Home | |
| may respond. One or more of the control system devices | |
| can be used manually, the “old-fashioned” way via touch. | |
| The Bedroom lights may turn off and on (e.g., manually). | Lights reliably work based on |
| | touch. |
| If in the Bedroom, the Omni App may be displayed in the | App displays “Bedroom View” |
| Bedroom View. The Omni App may change it's interface | |
| perhaps for example depending on the location of the user | |
| as determined by the Omni system. | |
| The control system may integrate the multiple “pseudo- | Display App controls, play |
| smart” systems into a (e.g., single) elegant experience. | music, turn fan on and off. |
| From this app, lights, music, the fan, your televisions and | |
| more can be controlled. | |
| The user's favorite combinations of device functions, may | App shows list of scenes. |
| be recorded to enable the homeowner's ability to record, | |
| save and/or recall Scenes. Any device or subsystem that | |
| can be controlled can be stored as part of the “Scene” | |
| including music, audio/video lighting, etc. | |
| Select “Sleep” mode may be made by the user (user may | Lights dim, Television timer |
| remain still). | set to 10 seconds, for example. |
| The user may want to go to the bathroom or the kitchen. | Bathroom lights turn on |
| The user may get out of bed (e.g., move around). Motion | w/motion. |
| detection may detect this and/or may activate your | |
| bathroom lights, dimmed to the user's liking. | |
| The Smart Home has the ability to light the way in a | |
| predictive manner. For example, late at night, the | |
| Smart Home may detect that where the user may be | |
| headed. The control system may activate lights ahead | |
| as the user leaves the bedroom, for example, so that the | |
| user might not enter a dark room. | |
| The user may proceed into Entry towards kitchen. | Kitchen Lights turn on |
| This may be referred to as predictive path, and it can be | |
| tailored and/or enabled for one or more, or each member | |
| of the household. | |

Table 3 lists some functions/attributes of the control system, for example in a kitchen.

TABLE 3

| Control System May Demonstrate | Smart Home Response |
|---|---|
| Kitchen | |
| The Omni App may turn Monitor toward kitchen. The view | App shows “Kitchen View” |
| on the App is “Kitchen View” perhaps because the Home | |
| may know the user is in the kitchen, via the device. | |
| The control system also provides security-via sensors and/or | App shows “Security Enabled” |
| Machine Learning sound detection. Security may be enabled | |
| on the App. | |
| If someone were to break into the home, the entry motion | Lights turn on, Audio alert |
| detection may trigger this alert. | plays, text is sent. |
| The user may receive a text alert. The control system device | Home returns to “Security |
| may display two buttons: Cancel (a false alarm) or Dispatch, | Enabled” state |
| where it's reported to authorities. | |
| The second approach is though the way in which the Smart | |
| Home recognizes particular sounds. Microphones embedded | |
| in the devices can “learn” to listen and react to particular | |
| sounds. For instance, glass breaking. | |
| If Breaking Glass sound is detected . . . | Lights turn on, Audio message |
| | plays, Text alert is sent |
| If Door Bell sound is detected . . . | Outdoor light turns on, Audio |
| | message plays. |
| If Smoke Alarm sound is detected . . . | Lights turn on, Audio message |
| | plays. |
| The technology may be packed inside the underutilized light | |
| switches. A convenient plug-in model may be useful for those | |
| seeking a simple retrofit from which they can enjoy control | |
| system capabilities. | |

In one or more scenarios, perhaps with just a few devices (e.g., each under $100) with the control system, you could have security, lighting control, and/or control of other devices on one app.

In one or more scenarios, the control system can do this, perhaps for example via a network of “light switches” that may provide Security, Lighting and Control of smart devices—all through one (or more) app, for example. In one or more scenarios, the control unit/processor may installed in any standard US light switch location.

In one or more scenarios, the control system may use interior triangulation based on system devices. In one or more scenarios, geo fencing of interior space may be made for “pet fencing purposes”. For example, triangulation and/or trilateration of pets, but with systems providing “sonic deterrent” or other limitations to pet movement. In one or more scenarios, distributed computing may be processed through one or more devices.

In one or more scenarios, personalization of users for preferences, tracking etc. may be configured. In one or more scenarios, predictive path lighting may be configured.

In one or more scenarios, an outlet version device may be used, a plug-in version may be used, and/or a 120v smoke detector replacement version may be used.

While the present disclosure has been illustrated and described in detail in the drawings and foregoing description, the same is to be considered as illustrative and not restrictive in character, it being understood that only certain embodiments have been shown and described, and that all changes and modifications that come within the spirit of the present disclosure are desired to be protected.

What is claimed is:

1. A first device for controlling one or more devices in a structure, the first device comprising:
a memory; and
a processor, the processor configured at least to:
detect one or more signals from a plurality of second devices;
determine one or more patterns based on the one or more signals;
determine at least one of: a compliance occurrence, or a deviation occurrence from the one or more patterns based on one or more parameters; and
indicate a pattern deviation upon a determination of a deviation occurrence.

2. The device of claim 1, wherein the first device is located in a centralized location in a structure.

3. The device of claim 1, wherein the plurality of second devices include at least one of: a light switch, a thermostat, or a motion sensor.

4. The device of claim 1, wherein the processor is further configured such that the one or more parameters include at least one of: a time interval, or a time period.
